(19) United States
(12) Patent Application Publication
(10) Pub. No.: US 2015/0004588 A1
(43) Pub. Date: Jan. 1, 2015

(54) Test Size Reduction via Sparse Factor Analysis

(71) Applicant: WILLIAM MARSH RICE UNIVERSITY, Houston, TX (US)

(72) Inventors: Divyanshu Vats, Houston, TX (US); Christoph E. Studer, Houston, TX (US); Richard G. Baraniuk, Houston, TX (US)

(21) Appl. No.: 14/317,937

(22) Filed: Jun. 27, 2014

Related U.S. Application Data
(60) Provisional application No. 61/840,853, filed on Jun. 28, 2013.

(51) Int. Cl. G09B 7/08

(52) U.S. Cl. CPC G09B 7/08
USPC 434/350; 434/353

(57) ABSTRACT

A database of questions is designed to test understanding of a set of concepts. A subset of the questions is selected for administering to one or more learners in a test. One desires for the subset to be small, to minimize testing workload for the learners and grading workload for instructors. However, to preserve the ability to accurately estimate learners' knowledge of the concepts, the questions of the subset should be appropriately chosen and not too small in number. We propose among other things a non-adaptive algorithm and an adaptive algorithm for test size reduction (TeSR) using an extended version of the Sparse Factor Analysis (SPARFA) framework. The SPARFA framework is a framework for modeling learner responses to questions. Our new TeSR algorithms find fast approximate solutions to a combinatorial optimization problem that involves minimizing the uncertainly in assessing a learner's knowledge of the concepts.

### PRIORITY CLAIM DATA

This application claims the benefit of priority to U.S. Provisional Application No. 61/840,853, filed Jun. 28, 2013, entitled “Test Size Reduction for Concept Estimation”, invented by Divyanshu Vats, Christoph E. Studer and Richard G. Baraniuk, which is hereby incorporated by reference in its entirety as though fully and completely set forth herein.

### GOVERNMENT RIGHTS IN INVENTION

This invention was made with government support under Grant Number DMS-0931945 awarded by the National Science Foundation. The government has certain rights in the invention.

### FIELD OF THE INVENTION

The present invention relates to the field of machine learning, and more particularly, to mechanisms for selecting a compact subset of questions from a database of questions that explore a set of concepts while maintaining the ability to accurately estimate how well learners understand the set of concepts.

### DESCRIPTION OF THE RELATED ART

Testing is a ubiquitous tool used for assessment. In educational scenarios, for example, a test on the prerequisites of a course (or class) can be useful in designing and adapting the course material (Wiggins, 1998; Benson, 2008), and/or for recommending remediation/enrichment for concepts each learner has weak/strong knowledge of (Hartley and Davies, 1976). In self-assessment scenarios, a test can allow learners to effectively plan a course of study in preparing for standardized tests, such as the SAT, ACT, GRE, or MCAT (Loken et al., 2004). In psychological scenarios, a test can be useful in informing a psychologist about characteristics of the testee that pertain to human behavior (Anastasi and Urbina, 1997).

In this patent disclosure, we consider the problem of designing efficient and accurate tests. In educational scenarios, when given a large database of questions that test learners' knowledge on multiple concepts, we are interested in selecting a small subset of “good” questions to accurately assess the learners' knowledge. A smaller subset is adantageous because it implies reduced time spent by learners in answering questions, and reduced time spent by graders and/or instructor in grading the answered questions. However, the ability to accurately estimate the learners' knowledge of the multiple concepts degrades if the questions defining the subset are chosen poorly and/or if the number of questions in the subset is too small. Thus, there exists a need for mechanisms capable of selecting a subset of questions from the database, where the subset has substantially reduced size but maintains the ability to accurately assess the knowledge of one or more learner's on the multiple concepts.

### SUMMARY

In one set of embodiments, a non-adaptive method for selecting questions from a set (or database) of questions may include the following operations.

The method may include receiving a question-concept matrix W representing strengths of association between questions in a set of questions and concepts in a set of concepts.

The method may include receiving a graded answer matrix representing grades for answers submitted by learners in response to the set of questions.

The method may include selecting a subset of the questions. The number of questions in the subset is less than or equal to the number of questions in the set of questions but greater than or equal to one plus the number of concepts in the set of concepts. The action of selecting the subset of questions may include: (a) for each of the concepts, selecting a corresponding question from the set of questions based on maximization of a variance-association product over the set of questions, where the variance-association product for each question is a product of a grade variance estimate for the question and a function of element wᵢⱼ of the matrix W corresponding to the question and the concept, where the grade variance estimate for each question is determined using a corresponding portion of the graded answer matrix; and (b) selecting an additional question from the set of the questions based on a maximization of a first objective function over the set of questions minus the questions selected in (a). For each question, the first objective function may be computed based on: a restriction of the question-concept matrix W corresponding to the question plus questions selected in (a), and, the grade variance estimates for the question and the questions selected in (a).

The method may also include storing information identifying the selected subset of questions in a memory. The selected subset of questions is configured to be administered to a new set of learners for testing knowledge of the new set of learners on the set of concepts.

In some embodiments, the method may include administering the selected subset of questions to the new set of learners, or generating (or designing) a test including the selected subset of questions. The action of administering and/or the action of generating may be performed by the above-mentioned computer system or by one or more other computer systems.

In another set of embodiments, an adaptive method for testing concept knowledge of a learner may include the following operations.

The method may include receiving initial grades for answers supplied by a learner in response to an initial subset of questions selected from a set of questions, where the set of questions are related to a set of concepts, where the number of questions in the initial subset is equal to at least one plus the number of concepts in the set of concepts, where strengths of association between questions in the set of questions and concepts in the set of concepts are represented by a question-concept matrix W.

The method may also include performing one or more iterations of a question selection process to successively add one or more questions to a current subset, where, prior to a first of the one or more iterations, the current subset is set equal to the initial subset. The question selection process may include: (1) determining if there are any concepts of the set of concepts that are not represented in the current subset of questions based on the question-concept matrix W and grades for answers provided by the learner for questions in the current subset; (2) in response to determining that one or more concepts are not represented in the current subset, selecting a next question for adding to the current subset based on a maximization of a first objective function over a question space equal to questions that map to the one or more concepts (as indicated by the matrix W) minus questions of the current subset, where, for each question, the first objective function is based on selected portions of the question-concept matrix W and a grade variance estimate corresponding to the question; (3) adding the selected next question to the current subset of questions; and (4) receiving a next grade corresponding to an answer provided by the learner in response to the selected next question.

Additional embodiments are described in U.S. Provisional Application No. 61/840,853, filed Jun. 28, 2013.

### BRIEF DESCRIPTION OF THE DRAWINGS

A better understanding of the present invention can be obtained when the following detailed description of the preferred embodiments is considered in conjunction with the following drawings.

FIG. 1A illustrates one embodiment of a client-server based architecture for providing personalized learning services to users (e.g., online users).

FIG. 1B illustrates one embodiment of a non-adaptive test-size reduction (TeSR) algorithm.

FIG. 1C illustrates one embodiment of an adaptive test-size reduction algorithm.

FIGS. 2A-2C give examples of synthetic W matrices generated for different values of the sparsity parameter. (See Section 6.2 for a description of α and and how matrix W is generated.) FIG. 2A illustrates a synthetic W matrix generated for α=0. FIG. 2B illustrates a synthetic W matrix generated for α=0.1. FIG. 2C illustrates a synthetic W matrix generated for α=0.2. In FIGS. 2A-2C, the rectangles are the question labels with their intrinsic difficulty. A link between a question and concept means that the question tests knowledge on that concept. In general, a lower (higher) a corresponds to a sparser (denser) W matrix.

FIGS. 3A-3F illustrates the mean and standard deviation of the RMSE-based performance measures as the number of questions selected varies from 20 to 100; “KC” refers to the knowledge component parameters; and “Ability” refers to the ability parameter. (RMSE is an acronym for “root mean squared error”.)

FIGS. 4A-4F illustrate the mean and standard deviation of the RMSE-based performance measures as the variance of the intrinsic difficulty varies from 0.25 to 36.0.

FIGS. 5A-5F illustrate the performance of the TeSR methods as the number of selected questions vary from 20 to 100. FIGS. 5A-5C show the mean values of the performance measures over 1000 trials. FIGS. 5D-5F illustrate the standard deviation of the performance measures over 1000 trials.

FIGS. 6A-6F illustrate the results of the TeSR methods with real data from a University admission test.

FIG. 7: Box-Whisker plot of the difficulty parameters in each real education data set. We clearly see that the 2011 data difficulty parameters have a wider range than the 2012 data difficulty parameters.

FIG. 8 illustrates one embodiment of a non-adaptive method for selecting a subset of questions from a set of questions, e.g., a subset of questions relevant for testing learners on a set of concepts.

FIG. 9 illustrates one embodiment of a method for adapatively selecting questions for a given user.

FIG. 10 illustrates one embodiment of a computer system that may be used to implement any of the embodiments described herein.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Incorporations by Reference

The following documents are hereby incorporated by reference in their entireties as though fully and completely set forth herein:

U.S. Provisional Application No. 61/840,853, filed Jun. 28, 2013, entitled “Test Size Reduction for Concept Estimation”, invented by Divyanshu Vats, Christoph E. Studer and Richard G. Baraniuk;

U.S. patent application Ser. No. 14/214,835, filed Mar. 15, 2014, entitled “Sparse Factor Analysis for Learning Analytics and Content Analytics”, invented by Baraniuk, Lan, Studer and Waters;

U.S. Provisional Application 61/790,727, filed Mar. 15, 2013, entitled “Sparse Factor Analysis for Learning Analytics and Content Analytics”, invented by Baraniuk, Lan, Studer and Waters.

### TERMINOLOGY

A memory medium is a non-transitory medium configured for the storage and retrieval of information. Examples of memory media include: various kinds of semiconductor-based memory such as RAM and ROM; various kinds of magnetic media such as magnetic disk, tape, strip and film; various kinds of optical media such as CD-ROM and DVD-ROM; various media based on the storage of electrical charge and/or any of a wide variety of other physical quantities; media fabricated using various lithographic techniques; etc. The term “memory medium” includes within its scope of meaning the possibility that a given memory medium might be a union of two or more memory media that reside at different locations, e.g., in different portions of an integrated circuit or on different integrated circuits in an electronic system or on different computers in a computer network.

A computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

A computer system is any device (or combination of devices) having at least one processor that is configured to execute program instructions stored on a memory medium. Examples of computer systems include personal computers (PCs), laptop computers, tablet computers, mainframe computers, workstations, server computers, client computers, network or Internet appliances, hand-held devices, mobile devices such as media players or mobile phones, personal digital assistants (PDAs), computer-based television systems, grid computing systems, wearable computers, computers implanted in living organisms, computers embedded in head-mounted displays, computers embedded in sensors forming a distributed network, computers embedded in a camera devices or imaging devices or measurement devices, etc.

A programmable hardware element (PHE) is a hardware device that includes multiple programmable function blocks connected via a system of programmable interconnects. Examples of PHEs include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores).

In some embodiments, a computer system may be configured to include a processor (or a set of processors) and a memory medium, where the memory medium stores program instructions, where the processor is configured to read and execute the program instructions stored in the memory medium, where the program instructions are executable by the processor to implement a method, e.g., any of the various method embodiments described herein, or, any combination of the method embodiments described herein, or, any subset of any of the method embodiments described herein, or, any combination of such subsets.

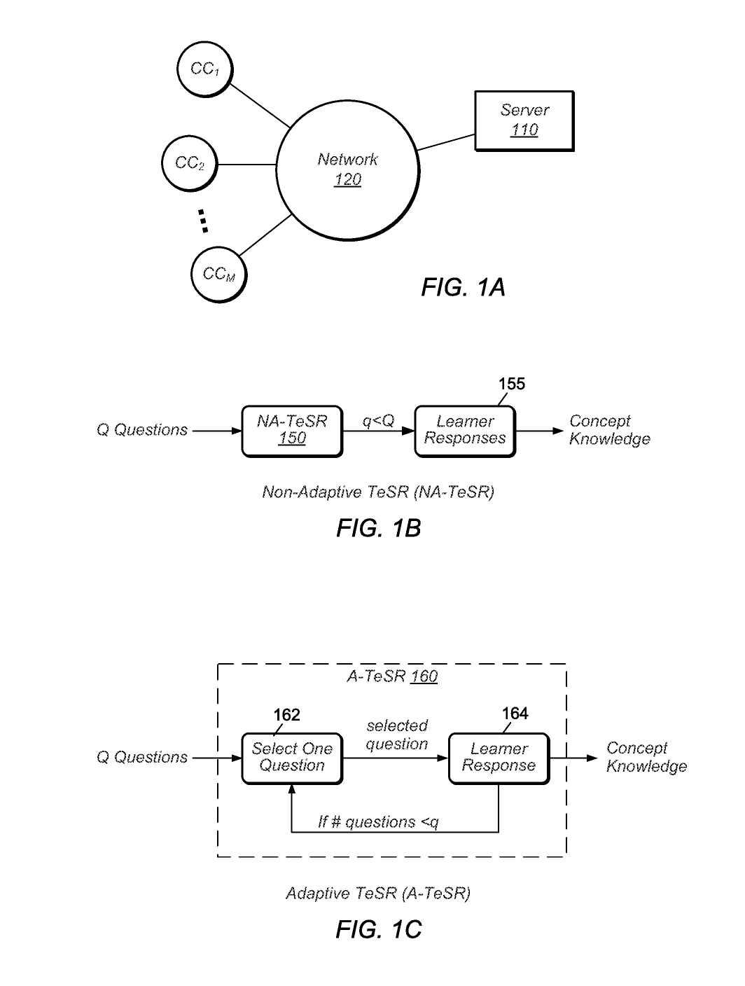

In one set of embodiments, a learning system may include a server 110 (e.g., a server controlled by a learning service provider) as shown in FIG. 1A. The server may be configured to perform any of the various methods described herein. Client computers CC₁, CC₂, . . . , CC_{M} may access the server via a network 120 (e.g., the Internet or any other computer network). The persons operating the client computers may include learners, instructors, graders, the authors of questions, the authors of educational content, etc. For example, learners may use client computers to access questions from the server and provide answers to the questions. The server may grade the learner-provided answers automatically based on correct answers previously provided, e.g., by instructors or the authors of the questions. (Of course, an instructor and a question author may be one and the same person in some situations.) Alternatively, the server may allow an instructor or other authorized person to access the answers that have been provided by learners. An instructor (e.g., using a client computer) may assign grades to the answers, and invoke execution of one or more of the computational methods described herein and/or one or more of the computational method described in U.S. patent application Ser. No. 14/214,835, filed Mar. 15, 2014 (entitled “Sparse Factor Analysis for Learning Analytics and Content Analytics”). Furthermore, learners may access the server to determine (e.g., view) their estimated concept-knowledge values (for the concepts) that have an extracted by the server, and/or, to view a graphical depiction of question-concept relationships determined by the server, and/or, to receive recommendations on further study or questions for further testing. In some embodiments, instructors or other authorized persons may access the server to perform one or more tasks such as: selecting questions from a data of questions, e.g., selecting questions for a new test to be administered for a given set of concepts; invoking execution of one or more of the test size reduction (TeSR) algorithms described herein; assigning tags (e.g., character strings) to questions; drafting new questions; editing currently-existing questions; drafting or editing the text for answers to questions; drafting or editing the feedback text for questions; viewing a graphical depiction of question-concept relationships; viewing the concept-knowledge values (or a graphical illustration thereof) for one or more selected learners; invoking and viewing the results of statistical analysis of the concept-knowledge values of a set of learners, e.g., viewing histograms of concept knowledge over the set of learners; sending and receiving messages to/from learners; uploading video and/or audio lectures (or more generally, educational content) for storage and access by the learners.

In another set of embodiments, a person (e.g., an instructor) may execute one or more of the presently-disclosed computational methods on a stand-alone computer, e.g., on his/her personal computer or laptop. Thus, the computational method(s) need not be executed in a client-server environment.

Test-Size Reduction VIa Sparse Factor Analysis

In designing educational tests, instructors often have access to a question bank that contains a large number of questions that test knowledge on the concepts underlying a given course. In this setup, a natural way to design tests is to simply ask learners to respond to the entire set of available questions. This approach, however, is clearly not practical since it involves a significant time commitment from both the learner (in taking the test) and the instructor (in grading the test, if it cannot be automatically graded). Hence, in this patent disclosure, we consider the problem of designing efficient and accurate tests so as to minimize the workload of both the learners and the instructors by substantially reducing the number of questions, or—more colloquially—the test size, while still being able to retrieve accurate estimates of concept knowledge. We refer to this test design problem as TeSR, short for “Test-size Reduction”. We propose among other things two novel algorithms, a non-adaptive variant and an adaptive variant, for TeSR using an extended version of the Sparse Factor Analysis (SPARFA) framework. The SPARFA framework is a framework for modeling learner responses to questions. Our new TeSR algorithms find fast approximate solutions to a combinatorial optimization problem that involves minimizing the uncertainly in assessing a learner's understanding of concepts. We demonstrate the efficacy of these algorithms using synthetic and real educational data, and we show significant performance improvements over state-of-the-art methods that build upon the popular Rasch model.

1 Introduction

Testing is a ubiquitous tool used for assessment. In educational scenarios, for example, a test on the prerequisites of a course (or class) can be useful in designing and adapting the course material (Wiggins, 1998; Benson, 2008), and/or for recommending remediation/enrichment for concepts each learner has weak/strong knowledge of (Hartley and Davies, 1976). In self-assessment scenarios, a test can allow learners to effectively plan a course of study in preparing for standardized tests, such as the SAT, ACT, GRE, or MCAT (Loken et al., 2004). In psychological scenarios, a test can be useful in informing a psychologist about characteristics of the testee that pertain to human behavior (Anastasi and Urbina, 1997).

In this patent disclosure, we consider the problem of designing efficient and accurate tests. In educational scenarios, when given a large database of questions that test learners' knowledge on multiple concepts, we are interested in selecting a small subset of “good” questions to accurately assess the testee's knowledge. Such tests can be useful in reducing the time spent by a testee, whom we refer to as a learner throughout the present disclosure, while still enabling accurate assessment of his/her concept knowledge. In psychological scenarios, a smaller list of questions can be useful in quickly determining the psychological construct of a testee. In what follows, we refer to such design problems as TeSR, short for Test-Size Reduction.

1.1 Summary

Going beyond the traditional ability-based statistical model (Rasch, 1960) (see Section 1.2 for a detailed discussion), we develop an extended version of the SPARse Factor Analysis (SPARFA) framework proposed in (Lan et al., 2014) to model learner responses to multiple-choice questions that test multiple concepts simultaneously. Specifically, while the conventional SPARFA framework associates a learner with a multidimensional vector of parameters that corresponds to their understanding in various concepts, extended SPARFA (eSPARFA) in addition associates an ability parameter with each learner. Given the eSPARFA framework, we leverage the theory of maximum-likelihood estimators (MLEs) to formulate TeSR as a combinatorial optimization problem that minimizes the uncertainty of the asymptotic error in estimating both the concept knowledge as well as the ability of each learner.

Among other things, we propose two TeSR algorithms, one non-adaptive and one adaptive, that approximate the resulting combinatorial optimization problem at low computational complexity. The non-adaptive TeSR algorithm, referred to as NA-TeSR (see FIG. 1B for an illustration of the working principle), reduces the test-size for the traditional setting where all learners are given the same test and the answers to the questions may be submitted roughly at the same time. NA-TeSR can be used to rank questions in order of their importance in accurately estimating the concept knowledge of learners. Such a ranking of questions cannot only be used as an aid by instructors when designing questions, but can also be used to improve the quality of questions that are ranked poorly. The adaptive TeSR algorithm, referred to as A-TeSR (see FIG. 1C for an illustration of the working principle), adapts the test questions to each individual learner, based on their previous responses to questions. The A-TeSR algorithm is capable of selecting an initial set of questions so that the MLE of the concept knowledge can be computed using as few questions as possible. (MLE is an acronym for “maximum likelihood estimate”.) To demonstrate the efficacy of the proposed TeSR algorithms, we show results for a range of experiments with synthetic data (that enables a comparison to a known ground truth) as well as with two real educational datasets. Experimental results on a real educational dataset show that TeSR can reduce the test size by 40%, without sacrificing predictive performance on unobserved learner responses. See Section 6.4 for more details.

FIG. 1B illustrates a non-adaptive TeSR (NA-TeSR) method 150, which accesses a set of Q questions related to a set of concepts. The NA-TeSR method selects q questions from the set of Q questions, where q<Q, where the selection process guarantees that the ability to accurately estimate the concept knoweldge of learners with respect to the set of concept is not compromised. The q selected questions are provided to learners, and the learners provide responses to the q selected questions, as indicated at 155. The responses may be graded, and the graded responses may be analyzed to estimate the concept knowledge of the learners with respect to the set of concepts.

FIG. 1C illustrates an adaptive TeSR (A-TeSR) method 160 for adaptively selecting questions for a given learner. The A-TeSR method includes a process 162 that selects a single question from a set of Q questions each time it is executed. (That single question is different from any previously selected questions.) The selected question is provided to the learner, who provides a response to the selected question, as indicated at 164. The response to the selected question is graded automatically, and an estimate of the learner's concept knowledge is comptued (e.g., using one of the SPARFA methods or one of the eSPARFA methods described herein). If the number of questions accumulated in selections up to the present time is less than q, the selection process 162 is executed again. (Parameter q is less than Q.) Thus, upon termination, the A-TeSR method will have selected q questions from the Q questions, and have computed an estimate of the concept knowledge of the learner. The A-TeSR method 160 selects the q questions so that the ability to accurately estimate the concept knowledge of learners with respect to the set of concepts is not compromised.

1.2 Related Work

Existing algorithms for selecting small subsets of questions primarily model the learner's responses to questions using item response theory (IRT) (Lord, 1980; Chang and Ying, 1996; Buyske, 2005; van der Linden and Pashley, 2010; GraBhoff et al., 2012). A comprehensive theoretical analysis of the corresponding algorithms has been carried out in (Chang and Ying, 2009). One prominent model used in IRT is the Rasch model (Rasch, 1960), where the probability of a learner answering a question correctly is modeled using a scalar ability parameter and a scalar question difficulty parameter. In contrast, the extended SPARFA (eSPARFA) model developed in the present disclosure models the learner's responses to questions using a multidimensional vector of not only the ability of a learner, but also the learner's knowledge of multiple concepts that are being tested in the given question set. In this way, eSPARFA more accurately models educational scenarios of tests comprising multiple concepts. Moreover, we show that the proposed TeSR algorithms lead to small tests, where the concept understanding of learners can be measured more accurately when compared to tests designed via the Rasch based model.

The eSPARFA framework performs factor analysis on binary-valued graded learner response matrices. (See, e.g., (Harman, 1976) for a description of factor analysis.) Previous factor analysis methods in the educational data mining literature include the Q-matrix method (Barnes, 2005; Desmarais, 2011), learning factors analysis (Cen et al., 2006), multi-way matrix factorization (Thai-Nghe et al., 2011), the instructional factor analysis (Chi et al., 2011), and collaborative filtering item response theory (Bergner et al., 2012). While these methods sometimes achieve good performance in predicting unobserved learner responses, there was no effort on trying to interpret the meaning of the estimated factors. In contrast, eSPARFA relies on several unique model assumptions on the factors, enabling the estimation of the learners' concept knowledge.

Some attempts have been made to use multidimensional item response theory (MIRT) for designing tests (Luecht, 1996; Segall, 1996; Wang et al., 2011). MIRT typically models learner responses to questions using a multidimensional ability parameter (Reckase, 2009; Ackerman, 1994). However, it has been shown that MIRT models have a highly undesirable property where a learner's ability may decrease after having answered a question correctly (Hooker et al., 2009; Jordan and Spiess, 2012). Thus, the questions selected through a MIRT-based approach are not necessarily useful for estimating the concept knowledge of learners. Furthermore, past work in selecting questions, both using IRT and MIRT, has mainly focused on adaptive methods, where future questions are selected based on prior responses. Our nonadaptive method for selecting questions is novel and appropriate for settings where all learners answer questions at the same time. This is the case, for example, in various massive open online courses (MOOCs) (Martin, 2012; Knox et al., 2012).

Finally, a related, but slightly different, problem to TeSR is that of designing intelligent tutoring systems (ITSs). In ITSs, the main goal is to provide instruction and feedback to learners using a computerized system without any human intervention (Anderson et al., 1982; Brusilovsky and Peylo, 2003; Stamper et al., 2007; Koedinger et al., 2012). One form of ITSs, employed in systems such as the Algebra Tutor (Ritter et al., 1998), the Andes Physics Tutoring System (Van-Lehn et al., 2005), and the ASSISTment (Feng and Heffernan, 2006), is to ask learners to answer questions associated with a concept, provide feedback, and iterate with different questions until the system believes that the learner understands the concept. Knowledge tracing (Corbett and Anderson, 1994), and its numerous variants (Baker et al., 2008; Pardos and Heffernan, 2011), are popular tools used in an ITS to track learner performance after questions are answered. Although ITSs perform some form of adaptive testing, the main goal in designing questions in an ITS is to teach a learner concepts through a series of questions and associated feedback. In contrast, the main objective in TeSR is to design a test with as few questions as possible, which allow one to accurately assess the concept knowledge of a learner. Nevertheless, we believe that the TeSR methods can be incorporated into ITS models in order to improve their performance using an extension of the methods in (Pardos and Heffernan, 2011).

2 Problem Formulation

In this Section, we formulate the test-size reduction (TeSR) problem, where we select a subset of questions such that the selected questions can accurately assess the concept knowledge of a learner. Although we formulate TeSR in the educational context, TeSR also applies in more general settings such as psychological surveys.

Section 2.1 summarizes the extended sparse factor analysis (eSPARFA) framework, which we use to model learner responses to questions. Section 2.2 formulates the TeSR problem using the eSPARFA framework.

2.1 Extended Sparfa Model

Suppose a question set contains Q questions that test knowledge from K knowledge concepts. For example, in a high-school mathematics course, questions could test knowledge from concepts like quadratic equations, trigonometric identities, or functions on a graph. Following the terminology put forward in (Corbett and Anderson, 1994), we refer to these concepts as knowledge components.

The original SPARFA framework introduced in (Lan et al., 2014) associates two sets of parameters with each question. The first set of parameters is a column vector wᵢεR₊^{K}, where R₊ is the set of non-negative real numbers. The vector wᵢ models the association of question i to all K knowledge components. Note that each question can be linked to multiple knowledge components. For example, solving the equation

x²−cos²(x)=sin²(x)+x for xεR

involves knowledge of both quadratic equations and trigonometric identities. (R denotes the set of real numbers.)

To model this, the j^{th} entry in vector wᵢ, which we denote by wᵢⱼ, measures the association of question i to knowledge component j. The SPARFA model assumes that this association cannot be negative, i.e.,

wᵢⱼ≧0,

which means that solving question i cannot reduce the understanding of knowledge component j. Furthermore, if question i does not test any skill from knowledge component j, then wᵢⱼ=0. To succinctly represent the question-knowledge component interactions among all Q questions, we concatenate the column vectors wᵢ, i=1, Q, to form the Q×K matrix W,

W=[w₁, . . . ,w_{Q}]^{T},

where the superscript T stands for the transpose. From the assumptions on wᵢ above, we see that W is, in general, a sparse matrix with non-negative entries. The second parameter associated with each question is a scalar μᵢεR that represents the intrinsic difficulty of the i^{th} question; the vector μ=[μ₁, . . . , μ_{Q}]^{T} contains the intrinsic difficulties for each question. In what follows, a larger (smaller) μᵢ designates an easier (harder) question.

Next, we define the parameters associated with a learner answering questions. It is these parameters that we are interested in estimating, using a small subset of the Q questions. In the original SPARFA model (Lan et al., 2014), the authors assumed that a learner can be modeled using a K×1 column vector c*εR^{K}, that measures the ability of a learner in the K knowledge components. In the extended SPARFA (eSPARFA) model used in this patent disclosure, a learner is modeled not only by the concept knowledge vector c*, but also by a scalar ability parameter a*εR. The properties and advantages of this additional ability parameter in eSPARFA are discussed in Remarks 1 and 3 below. See Table 1 for a summary of the parameters associated with the eSPARFA model.

TABLE 1
Main Parameters of the extended SPARFA (eSPARFA) model

| Notation | Description |
|---|---|
| W | Sparse matrix (with non-negative entries) that characterizes |
| | the relationship between questions and knowledge components |
| μ | Vector that specifies the instrinsic difficulty of each question |
| c* | Vector that represents a learner's ability in each knowledge |
| | component |
| a* | Scalar that measures a learner's overall ability |

To model the interplay between wᵢ, μ, c*, and a*, let Yᵢ be a random variable that denotes the graded response of the learner to question i. If we assume that Yᵢε{0, 1}, which denotes whether a learner provides a correct (corresponding to 1) or incorrect (corresponding to 0) response, then eSPARFA models the graded response Yᵢ as

P(Yᵢ=1|wᵢ,c*,a*)=Φ(wᵢ^{T}c*+a*+μᵢ), (1)

where Φ(x) is the inverse logistic link function defined as

Φ(x)=(1+exp(−x))⁻¹,

wᵢεR₊^{K},μᵢ,a*εR, and c*εR^{K}.

We note that the eSPARFA framework can be modified to consider the inverse probit link function, ordinal graded response data (e.g., from tests with partial credit), or categorical responses (e.g., from surveys); see (Lan et al., 2013) for the details. Before formulating the TeSR problem based on eSPARFA, we make some important remarks.

Remark 1 (Rasch model). We point out that eSPARFA corresponds to a generalization of item response theory (IRT) building upon the Rasch model (Rasch, 1960). In particular, if K=0, then the eSPARFA model (1) reduces to the Rasch model, i.e., the probability of answering a question correctly solely depends on a student's ability and the intrinsic difficulty of a question. Several extensions of the Rasch model, also known as the 1PL model, have been proposed in the literature (Baker and Kim, 2004). The 2PL model assumes that questions can be modeled by a difficulty and a discrimination parameter. This discrimination parameter is the degree to which a question discriminates between learners with varying abilities. The 3PL model includes, in addition, a guessing parameter with every question signifying the extent to which learners will make a guess when answering that question. The extension of the eSPARFA framework to both the 2PL and the 3PL model is straightforward, which is why we focus mainly on the 1PL model. The eSPARFA model is also related to cognitive diagnosis model (Templin and Henson, 2006). In particular, the W matrix in cognitive diagnosis models has binary or categorical entries, while the entries of W in the eSPARFA model are real-valued entries.

Remark 2 (Interpretability of eSPARFA). The key assumption in the eSPARFA model, which was introduced in (Lan et al., 2014), is that the matrix W is sparse with non-negative entries. The sparsity assumption says that the questions do not, in general, test knowledge from all knowledge components, but only a few of the knowledge components. The non-negativity assumption allows for the knowledge component vector c* to be interpretable. In particular, if cⱼ* is large and positive (small and negative), and a learner answers a question that only tests knowledge from knowledge component j, then the probability of answering the question will likely be closer to one (zero).

Remark 3 (Ability parameter). The eSPARFA framework extends SPARFA in (Lan et al., 2014) by adding the ability parameter a*. In the literature, the introduction of such a parameter is sometimes referred to as a random effect (Kreft and de Leeuw, 1998). In practice, the need for using a* depends on the data available for parameter estimation and/or the number of concepts associated with the questions. Some motivations for introducing this additional parameter are given as follows:

(i) If wᵢ is estimated to be a vector of zeros (see Remark 4 for how wᵢ is estimated), then question i does not test knowledge from any of the knowledge components. In such cases, SPARFA deems the question irrelevant, since the probability of answering the question correctly will not depend on the learner-dependent parameters but only on the intrinsic difficulty. This situation, however, is evidently not desirable in a statistical model, as the provided responses naturally depend on the learner's abilities.

(ii) The eSPARFA framework characterizes the overall ability of a learner across all knowledge components. Such information is not necessarily conveyed in the concept knowledge vector of the original SPARFA framework. For example, consider a test containing only difficult questions testing knowledge from three knowledge components. If a learner answers a small number of questions incorrectly, all from a single knowledge component, then SPARFA would estimate the learner's concept knowledge in this component to be relatively weak when compared to the learner's concept knowledge in other components. However, the information that the learner's overall ability is high (since they answered most of the hard questions correctly) is lost when extracting only the concept knowledge vectors. In contrast, the eSPARFA framework is able to characterize both, the overall ability as well as the individual concept knowledge.

We emphasize that the ability parameter may not be needed in some settings and this can be tested when performing parameter estimation (see Remark 4). In such cases, all the algorithms we introduce for test-size reduction will still apply. In such cases, the ability parameter may simply be set to zero, or alternatively, removed from the algorithms entirely.

Remark 4 (Identifiability and parameter estimation). Given graded response data from multiple learners, the parameters W and μ in the eSPARFA model can be estimated using suitably modified versions of the SPARFA-M or SPARFA-B algorithms proposed in (Lan et al., 2014). In all our simulations, we use the SPARFA-M algorithm that estimates W and using regularized maximum likelihood estimation. In practice, a set of graded responses for estimating W and μ can be obtained from a previous offering of a course. Finally, we note that the eSPARFA model is clearly not identifiable. We refer to (Lan et al., 2014) for a discussion of how some identifiability problems can be avoided by appropriate regularization of some parameters. Furthermore, it is clear that eSPARFA depends on choosing a suitable number of knowledge components, i.e., the value K. There are several ways in which K can be chosen appropriately. For example, K can be set using cross-validation, using Bayesian methods as in (Fronczyk et al., 2013), or using prior information about the course content. We assume that the parameters W and μ are known.

2.2 Test-Size Reduction (TeSR)

We now formulate the test-size reduction (TeSR) problem of selecting an appropriate subset from a set of Q given questions, i.e., a subset sthat enable us to obtain accurate estimates for the learner dependent parameters c* and a*. Suppose, that we select a subset I of |I|=q<Q questions, and we are given the corresponding graded response vector y_{I}. Following the model in (1), and by assuming that all random variables Y₁, . . . , Y_{Q} are independent given the parameters W, c*, and a*, the joint probability distribution of Y_{I} is given by

$$P ( {Y}_{I} = {y}_{I} \vert W , μ , {c}^{*} , {a}^{*} ) = {\prod }_{i ∈ I} \frac{exp ( {y}_{i} ( {w}_{i}^{T} {c}^{*} + {a}^{*} + {μ}_{i} ) )}{1 + exp ( {w}_{i}^{T} {c}^{*} + {a}^{*} + {μ}_{i} )} . \qquad ( 2 )$$

Here, the vector y_{I} contains the responses of the learner to the questions I. To see if the independence assumption in (2) is reasonable, for any i≠i′, consider the conditional probability

P(Yᵢ=1|W,μ,c*,a*,Y_{i′}).

Since the student parameters are known, it is likely that the response of the student to question i′ will not influence the response of the student to question i. This intuition validates the independence assumption. The maximum likelihood estimate (MLE) of the knowledge component vector c* and the ability parameter a* can be written as follows:

$$\begin{matrix}\{ \hat{c} , \hat{a} \} = {argmax}_{c ∈ {R}^{K} , a ∈ R} log P ( {Y}_{I} = {y}_{I} \vert W , μ , c , a ) & ( 3 A ) \\ = {argmax}_{c ∈ {R}^{K} , a ∈ R} {\sum }_{i ∈ I} [ \begin{matrix}{y}_{i} ( {w}_{i}^{T} c + a + {μ}_{i} ) - \\ log ( 1 + exp ( {w}_{i}^{T} c + a + {μ}_{i} ) )\end{matrix} ] . & ( 3 B )\end{matrix}$$

Given y_{I}, W, and the problem (3) can be solved via standard convex optimization methods (see, e.g., (Boyd and Vandenberghe, 2004)). The main objective in TeSR is to find an appropriate subset I such that the estimates ĉ and â are as close as possible to the true unknown parameters c* and a*, respectively. In order to analytically formulate the TeSR problem, we make use of the fundamental asymptotic normality property of MLEs (see, e.g., (Fahrmeir and Kaufmann, 1985) for more details). Before stating the Theorem, we define the Fisher information matrix by

$${F}_{I} = {\sum }_{i ∈ I} {\frac{exp ( {w}_{i}^{T} {c}^{*} + {a}^{*} + {μ}_{i} )}{{( 1 + exp ( {w}_{i}^{T} {c}^{*} + {a}^{*} + {μ}_{i} ) )}^{2}} [ {w}_{i}^{T} , 1 ]}^{T} [ {w}_{i}^{T} , 1 ] \qquad ( 4 )$$

where [wᵢ^{T}, 1]^{T} designates a column vector consisting of wᵢ and the scalar 1.

Theorem 1 (Asymptotic normality property (Fahrmeir and Kaufmann, 1985)). Suppose the Fisher information matrix F_{I} in (4) is invertible for all subsets I such that q=|I|≧K+1, and let

e=q^{1/2}([ĉ,â]^{T}−[c*,a*]^{T})

be the scaled error in estimating the learner-dependent parameters. Then, as q→∞, the scaled error e converges in distribution to a multivariate normal vector with mean zero and covariance F_{I}⁻¹, i.e., we have e converges in distribution to N(0, F_{I}⁻¹).

Note that F_{I} is a K+1×K+1 matrix, and so we need at least K+1 questions for F_{I} to be invertible. Theorem 1 states that as the number of questions q grows, the probability distribution of the error vector

e=q^{1/2}([ĉ,â]^{T}−[c*,a*]^{T})

converges to a multivariate normal distribution with mean zero and covariance given by the inverse of the Fisher information matrix. The main assumption in Theorem 1 is for the Fisher information matrix F_{I} to be invertible for all choices of the set of questions I. Since F_{I} depends on W, the invertibility of F_{I} implicitly imposes assumptions on the question-knowledge component matrix W.

As mentioned earlier, the main goal in TeSR is to select the subset of questions I so that the error e is as small as possible. Since we have an approximation of the distribution of e, one way of selecting I is to ensure that the uncertainty in the random vector e is minimal. A natural way of measuring the uncertainty in a random vector is the differential entropy (Cover and Thomas, 2012), which, for a multivariate normal random vector with mean zero and covariance E, is given by

log((2πe)^{q}det(Σ)).

Consequently, we define the TeSR optimization problem as

$$( TeSR ) \hat{I} = {argmax}_{I ∈ \{ 1 , … , Q \} , \vert I \vert = q} log det ( {F}_{I} )$$

There are two main challenges in finding the solution to the TeSR problem:

(i) The objective function, in general, cannot be computed exactly, as it depends on the (typically) unknown learner-dependent parameters c* and a*.
(ii) The optimization problem is combinatorial in nature, as it involves an exhaustive search over all

$$( \begin{matrix}Q \\ q\end{matrix} )$$

subsets of questions.

In Section 3, we address the first problem by approximating the objective function in (TeSR) by means of prior data available on the learner-dependent parameters. Subsequently, in Section 4, we address the second problem by approximating the solution to the combinatorial optimization problem using greedy methods.

3 Approximating the TeSR Problem Using Prior Data

In this section, we show how the TeSR objective function, which cannot be evaluated exactly (because it depends on unknown parameters), can be approximated using prior data from multiple learners answering questions. Recall that the random variable Yᵢ denotes the graded response of a learner to the question. Using the probability distribution of Yᵢ in (1), we see that the scalar term in the summation of (4) corresponds to the variance of the random variable Yᵢ, i.e., the following relation holds:

$$Var [ {Y}_{i} \vert {c}^{*} , {a}^{*} ] = \frac{exp ( {w}_{i}^{T} {c}^{*} + {a}^{*} + {μ}_{i} )}{{( 1 + exp ( {w}_{i}^{T} {c}^{*} + {a}^{*} + {μ}_{i} ) )}^{2}} \qquad ( 5 )$$

The variance Var[Yᵢ|c*,a*] captures the variability of the learner's graded response in answering the ith question. By defining V as a Q×Q diagonal matrix with entries vᵢᵢ=Var[Yᵢ|c*, a*] on the main diagonal, the TeSR problem can be rewritten as

$$\hat{I} = {argmax}_{I ∈ \{ 1 , … , Q \} , \vert I \vert = q} log det ( {\overline{W}}_{I}^{T} {V}_{I} {\overline{W}}_{I} ) \qquad ( 6 )$$

with W̅_{I}=[1, W_{I}], where W̅_{I} is the q×K+1 matrix corresponding to the rows of W̅ that are indexed by I and 1 is an all ones column vector of appropriate dimension. Note that the matrix V_{I} is unknown, in general, as it depends on the unknown learner-dependent parameters c* and a*. To approximate the objective function in (6), we use an estimate of the variance Var[Yᵢ|c*, a*]. To this end, let \tilde{Y} be a Q×N graded response matrix, e.g., obtained from a previous offering of the same course. This matrix can be built from the same data used to estimate the parameters W and μ as mentioned in Remark 4. With this response matrix, we now define the empirical variance of each row of \tilde{Y} as

$${\tilde{v}}_{ii} = \frac{1}{N} {\sum }_{j = 1}^{N} ( {\tilde{Y}}_{ij} - \frac{1}{N} {\sum }_{j = 1}^{N} {\tilde{Y}}_{ij} ) \qquad ( 7 )$$

Let \tilde{V} be a diagonal matrix with the diagonal entries given by \tilde{v}ᵢᵢ. Using \tilde{V} as a proxy for the true variances contained in V, a solution to (5) can be approximated by

$$\tilde{I} = {argmax}_{I ∈ \{ 1 , … , Q \} , \vert I \vert = q} log det ( {\overline{W}}_{I}^{T} {\tilde{V}}_{I} {\overline{W}}_{I} ) \qquad ( 8 )$$

The rationale behind this approximation is that the responses in \tilde{V} are assumed to be from learners with the same parameters c* and a*. In light of no other available information about the learner, the above approximation seems reasonable—we will see numerical simulations in Section 6 showing the efficacy of using the above approximation in practice. In particular, we compare our proposed approximation to another approximation that completely ignores the variance term, i.e., assumes that the diagonal entries \tilde{v}ᵢᵢ of \tilde{V}_{I} are the same for all i=1, . . . , Q. Finally, since (8) is independent of the learner-dependent parameters, it can be used to extract a subset of questions for multiple learners in a class so that all learners receive the same set of questions. In the next section, we propose a greedy algorithm for finding an approximate solution to the combinatorial optimization problem in (8).

4 Non-Adaptive Test-Size Reduction (NA-TeSR)

In this section, we develop an algorithm for non-adaptive test-size reduction, referred to as NA-TeSR. As illustrated in FIG. 1B, we will design an algorithm that selects q questions from a database of Q questions and then, use the selected questions to assess the concept knowledge of learners. We proceed by solving the optimization problem in (8) using methods that resemble those for sensor selection (Joshi and Boyd, 2009; Shamaiah et al., 2010) in signal processing, where it is desirable to select a small number of sensors from a large collection of sensors monitoring an environment. Although the statistical model for sensor measurements differs significantly from the eSPARFA model in (1), the problem formulation of TeSR in (8) is similar to the problem formulation of sensor selection. There are two prominent approaches for sensor selection in the literature. The first approach is based on convex optimization (Joshi and Boyd, 2009) and the second on greedy methods (Shamaiah et al., 2010). The greedy method has advantages over the convex optimization approach in terms of computational complexity and has been shown to lead to superior empirical performance (Shamaiah et al., 2010). For this reason, we solely focus on a greedy approach to find an approximate solution to (8).

Algorithm 1: Nonadaptive test-size reduction (NA-TeSR)

Step 1: For each knowledge component j, where j ε {1,...,K}, select a
question i (from the set of all unselected questions) such that \tilde{v}ᵢᵢwᵢⱼ² is
maximum.
Step 2: Select the (K+1)^{th} question by solving
Ĩ_{K+1} = arg max_{iε[Q]\Ĩ}_{_{[K]}} log det ( W̅_{Ĩ}_{_{[K]}}_{∪i}^{T}\tilde{V}_{Ĩ}_{_{[K]}}_{∪i,Ĩ}_{_{[K]}}_{∪i} W̅_{Ĩ}_{_{[K]}}_{∪i),}
where Ĩ_{[K]} denotes the set of first K questions selected in Step 1.
Step 3: For l = K+1,..., q−1, select the (l+1)^{th} question by solving
Ĩₗ₊₁ = arg max_{iε[Q]\Ĩ}_{_{[l]}} \tilde{v}ᵢᵢ[wᵢ^{T},1]( W̅_{Ĩ}_{_{[l]}}^{T}\tilde{V}_{Ĩ}_{_{[l]}}_{,Ĩ}_{_{[l]}} W̅_{Ĩ}_{_{[l]}})⁻¹[wᵢ^{T},1]^{T},
where Ĩ_{[l]} denotes the set of first l questions selected.

Algorithm 1 summarizes the steps of the proposed non-adaptive TeSR (NA-TeSR) algorithm. For a set I, let I_{[l]} be the first l elements of I and let Iₗ be the l^{th} element of I. Note that F_{I} is a K+1×K+1 matrix. Thus, to obtain accurate estimates of c* and a*, we need to select at least K+1 questions. We now elaborate on the three steps of Algorithm 1.

1) The first step in NA-TeSR selects a set of K questions Ĩ_{[K]} that contains one question from every knowledge component. To do so, note that the Fisher information of the parameter c*ₗ is given by

$${\sum }_{i ∈ I} Var [ {Y}_{i} \vert {c}^{*} , {a}^{*} ] {w}_{ij}^{2} ,$$

where wᵢⱼ is the (i, j)^{th} entry of W. Thus, to select the most informative question for every knowledge component in a greedy manner, we want to select a question i so that wᵢⱼ Var[Y|c*, a*] is maximized. Substituting the approximation n in lieu of the unknown variance Var[Yᵢ|c*, a*], we obtain the strategy for selecting question I so that \tilde{v}ᵢᵢwᵢⱼ² is maximized.

2) The second step in NA-TeSR selects the (K+1)th question so that the objective det( W̅_{I}_{_{[K+1]}}^{T}\tilde{V}_{I}_{_{[K+1]}}_{,I}_{_{[K+1]}} W̅_{I}_{_{[K+1]}}) is maximized, where I_{[K]}=Ĩ_{[K]}. This maximization can easily be achieved by searching over all the remaining questions to select the (K+1)^{th} question.

3) The third step selects the remaining questions in a greedy manner using a step that is similar to Step 2 except that a simple trick, motivated from (Shamaiah et al., 2010), is used to simplify the computations. In particular, if I_{N} are the l questions selected, where l≧K+1, then the (l+1)^{th} question can be selected by det( W̅_{I}_{_{[l+1]}}^{T}\tilde{V}_{I}_{_{[l+1]}}_{,I}_{_{[l+1]}} W̅_{I}_{_{[l+1]}}) where I_{[l]}=Ĩ_{[l]}. Using the well-known identity det(X+bb^{T})=det(X)(1+b^{T}X⁻¹b), where X is a square matrix and b is a column vector, we have that

det( W̅_{I}_{_{[l+1]}}^{T}\tilde{V}_{I}_{_{[l+1]}}_{,I}_{_{[l+1]}} W̅_{I}_{_{[l+1]}})=det(M)(1+\tilde{v}_{I}_{ₗ₊₁}_{,I}_{ₗ₊₁}[w_{I}_{ₗ₊₁}^{T},1]M⁻¹[w_{I}_{ₗ₊₁}^{T},1]^{T}), (9)

where M= W̅_{Ĩ}_{_{[l]}}^{T}\tilde{V}_{Ĩ}_{_{[l]}}_{,Ĩ}_{_{[l]}} W̅_{Ĩ}_{_{[l]}}. Since M is known, (9) can be easily maximized.

In summary, NA-TeSR solves the TeSR problem (8) in a greedy manner by selecting a locally optimal question in each iteration.

Remark 5 (Comparison to the Rasch model). As mentioned in Remark 1, the eSPARFA model reduces to the Rasch model when K=0. In this case, it is easy to see that the TeSR problem reduces to choosing a set I that maximizes

$${\sum }_{i ∈ I} Var [ {Y}_{i} \vert {a}^{*} ] ,$$

where Yᵢ is the random variable representing the graded response to the ith question. Since the Rasch model ignores the question-knowledge component relationship, the TeSR problem, in this particular case, is no longer computationally challenging, and each question can be selected independently. On the other hand, since eSPARFA models question-knowledge component relationships, as we see in Algorithm 1, the questions can no longer be selected independently. Furthermore, we refer to Section 6 for numerical results on synthetic and real data that show the benefits of using NA-TeSR versus Rasch-based methods when the questions test knowledge on multiple knowledge components.

5 Adaptive Test-Size Reduction (A-TeSR)

In this section, we develop an algorithm for adaptive test-size reduction, referred to as A-TeSR. In section 4, we introduced the non-adaptive TeSR algorithm, where all the questions are selected at the same time before learners submit their responses to the questions. However, in many settings, tests are computerized, and the questions can be selected in an adaptive manner. In such cases of adaptive testing, the individual response history of learners can be used to adaptively select the “next best” question (in terms of minimizing each learner's estimation error). Adaptive tests are popularly employed when learners take standardized tests such as the SAT, ACT, or GRE (van der Linden and Glas, 2000).

From the perspective of the TeSR problem formulation, the response history of a learner allows for an alternative approach to approximate the TeSR objective function using the parameters estimated from the response history instead of prior data from other learners. This appealing property of adaptive testing can potentially allow adaptive tests to ask fewer questions to assess concept knowledge of learners. However, in order to implement an adaptive testing al-gorithm, it is important to be able to estimate the intermediate knowledge component parameters computed after a learner responds to a question. Although these parameters can be estimated using maximum likelihood, the maximum likelihood estimator (MLE) may not exist for certain choices of the questions. Thus, it is important to understand the specifics of where the MLE may not exist and devise an algorithm to avoid such situations. In Section 5.1, we discuss conditions under which the MLE exists. In Section 5.2, we use these conditions to develop a strategy to adaptively select questions.

5.1 Existence of the Maximum-Likelihood Estimator (MLE)

In an adaptive testing scenario, the learner-dependent parameters, c* and a*, are re-estimated after each question is answered. In particular, if y_{I} is the graded learner response to the questions indexed by I, then the MLE of c* and a* is given by

$$\{ \hat{c} , \hat{a} \} = {argmax}_{c ∈ {R}^{K} , a ∈ R} {\sum }_{i ∈ I} [ \begin{matrix}{y}_{i} ( {w}_{i}^{T} c + a + {μ}_{i} ) - \\ log ( 1 + exp ( {w}_{i}^{T} c + a + {μ}_{i} ) )\end{matrix} ] \qquad ( 10 )$$

Although the objective function in (10) is convex, it is not strictly convex. For this reason, the MLE may diverge to infinity. In this case, we say that the MLE does not exist. To avoid this situation, it is important to carefully select the next best question. To this end, we make use of the following existence theorem.

Theorem 2. Suppose the graded responses y_{I} from questions I follow a distribution given the eSPARFA model in (1). Further, for the knowledge component j, let Sⱼ be the indices for which wᵢₖ>0. If y_{S}_{ⱼ}_{∩I}=0 or if Y_{S}_{ⱼ}_{∩I}=1, then the MLE of c*ⱼ does not exist. Further, if y_{I}=0 or if y_{I}=1, then the MLE of a* does not exist.

Informally, Theorem 2 states that if the graded responses to the questions associated with a knowledge component are all incorrect (indicated by 0) or all correct (indicated by 1), then the MLE of the parameters associated with that knowledge component does not exist. In addition, Theorem 2 states that if all responses to the questions are either incorrect or correct, then the MLE of the ability parameter does not exist. As an example, consider the following matrix W and the graded response vector y:

$$W = [ \begin{matrix}0.2 & 0 & 0.3 \\ 0 & 1.4 & 0.7 \\ 0.1 & 0 & 0 \\ 0 & 0.2 & 0\end{matrix} ] , y = [ \begin{matrix}0 \\ 1 \\ 0 \\ 0\end{matrix} ] . \qquad ( 11 )$$

According to the notation in Theorem 2, we have I={1, 2, 3, 4}. Further, S₁={1, 3} is the set of all questions associated with the first knowledge component. To check whether the MLE for c*ᵢ exists, we inspect y_{S}_{ⱼ}_{∩I}=[y₁, y₃]. Since both these entries are zero, according to Theorem 2, the MLE of c*₁ does not exist. When confronted with such a situation, we will see in Section 5.2, that the proposed A-TeSR algorithm will select a suitable question that tests knowledge from the first knowledge component.

Remark 6 (Necessary conditions for MLE existence). Note that the condition in Theorem 2 is only a sufficient condition for the MLE to exist. In other words, even if the condition in Theorem 2 holds, it is not guaranteed that the MLE will exist. The necessary and sufficient conditions, as shown in (Albert and Anderson, 1984) for generalized linear models, depends on the rows in the matrix W. An open research problem is to design a method that can completely avoid the conditions for which the MLE does not exist using as few questions as possible. As detailed in Section 5.2, in the event that the MLE does not exist, and the condition in Theorem 2 is not satisfied, we use NA-TeSR to select select the next question.

5.2 Adaptive Test-Size Reduction (A-TeSR) Algorithm

Algorithm 2: Adaptive test-size reduction (A-TeSR)

```
Select K+1 questions Ĩ_{[K+1]} using Steps 1 and 2 of Algorithm 1.
Acquire graded learner responses y_{Ĩ}_{_{[K+1]}}.
for j = K+1,..., q−1 do
  if condition in Theorem 2 is satisfied then
    Let Q be all questions that map to knowledge components that satisfy
    the condition in Theorem 2.
    Select the (j+1)^{th} question, Ĩⱼ₊₁, using Step 3 of Algorithm 1 such that
    the maximum is over the questions Q\Ĩ_{_{[j]}}.
  if condition in Theorem 2 is not satisfied then
    Compute the MLEs c and a using y_{Ĩ}_{_{[j]]}}.
    if ĉand âexist then
      Find Ĩⱼ₊₁ using Step 3 of Algorithm 1 by replacing \hat{V}ᵢᵢ with
      Var[Yᵢ|c,a], which is computed using (5).
    else
      Find Ĩⱼ₊₁ using Step 3 of Algorithm 1.
  Acquire graded learner responses y_{Ĩ}_{ⱼ₊₁}.
endfor
```

A-TeSR (see Algorithm 2) summarizes the steps involved in the proposed adaptive test-size reduction algorithm. We start by selecting K+1 questions using the first two steps of NA-TeSR (Algorithm 1) and acquire graded responses from a learner. Note that this step of the algorithm is independent of the learner parameters and is also non-adaptive. The selection of the remaining questions depends on whether the learner parameters can be estimated given graded responses or not. In particular, if the condition in Theorem 2 is satisfied for a knowledge component, then the MLE of that knowledge component parameter diverges to infinity. In this case, we find all questions, say the set Q, that are associated with a knowledge component that satisfies the condition in Theorem 2. Next, we select a question from the predefined set Q that maximizes the objective in Step 3 of the NA-TeSR algorithm.

If the condition in Theorem 2 is not satisfied for any knowledge component, then the MLE of the learner parameters may exist. This existence can be checked in practice using methods in (Konis, 2007). If the MLE exists, we no longer need to use the approximation of the TeSR problem in (8). Instead, we substitute c* with ĉ and a* with â to find a new approximation of the TeSR objective function. If the MLE does not exist, we simply perform Step 3 of NA-TeSR to select the next question.

Remark 7. Just as in the case of the non-adaptive algorithm, when K=0, Algorithm 2 reduces to an adaptive Rasch model-based method; see (Chang and Ying, 2009) for examples of such algorithms. As highlighted before, the eSPARFA model used to formulate TeSR takes into account the dependencies among questions, while the Rasch model does not account for such dependencies. Note that Rasch model-based adaptive testing has the natural interpretation that every question selected is such that its difficulty matches the learner's ability (or estimated ability). This is because such a question choice maximizes the variance of the learner response, i.e., the variance of the random variable Yᵢ, defined in (1), conditioned on the question and student parameters. In contrast, the A-TeSR based method, that depends on the eSPARFA model with K>0, does not have such an interpretation. Regardless, our numerical simulations clearly show the benefits of using the eSPARFA model for adaptive testing in situations where questions test knowledge on multiple concepts.

6 Experimental Results

In this section, we assess the performance of NA-TeSR and A-TeSR for test-size reduction on synthetic and real educational data. Section 6.1 describes the simulation setup. Sections 6.2 and 6.3 discuss synthetic results for NA-TeSR and A-TeSR, respectively. Section 6.4 provides results for both A-TeSR and NA-TeSR with real educational data.

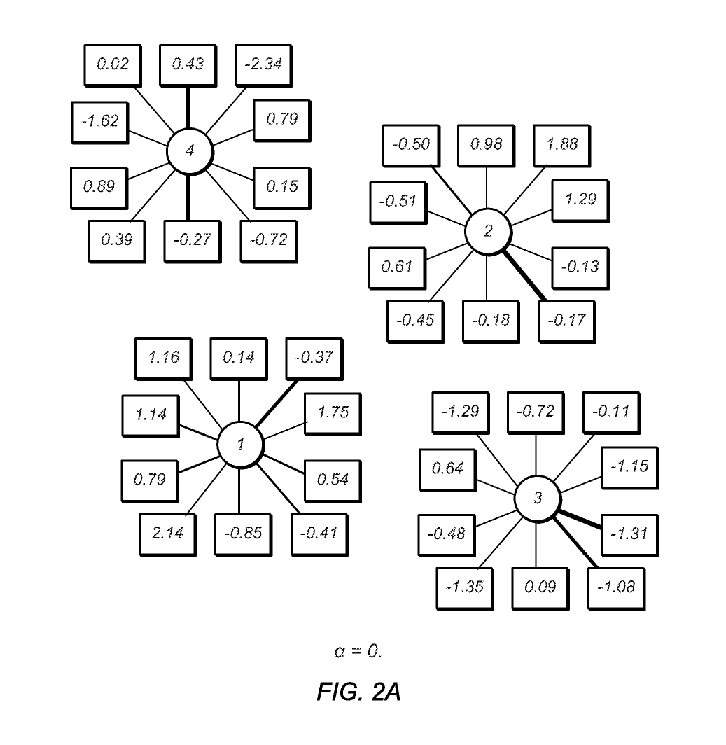

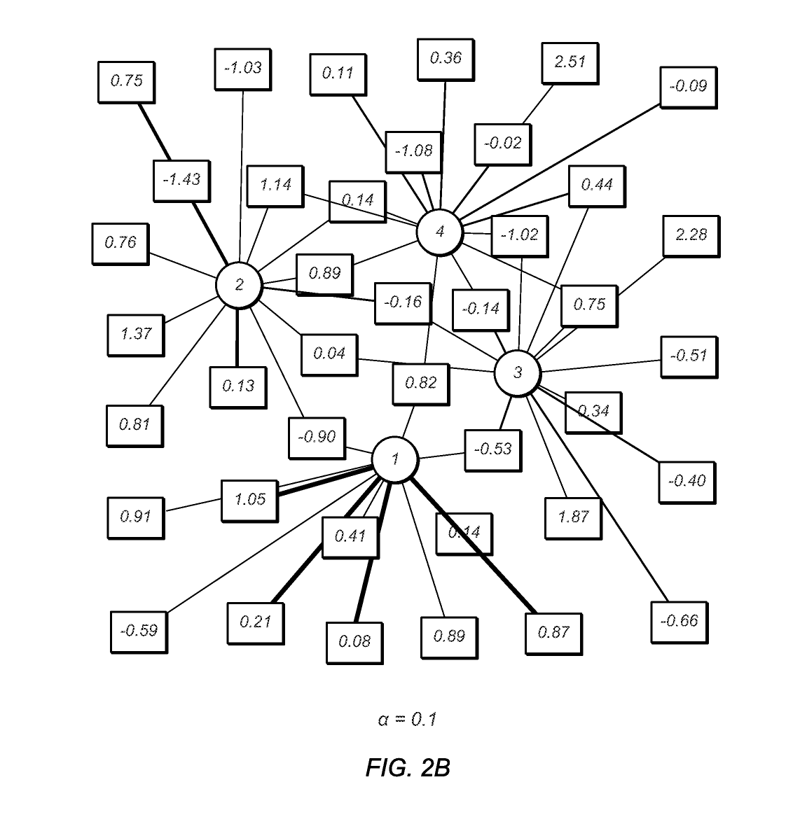

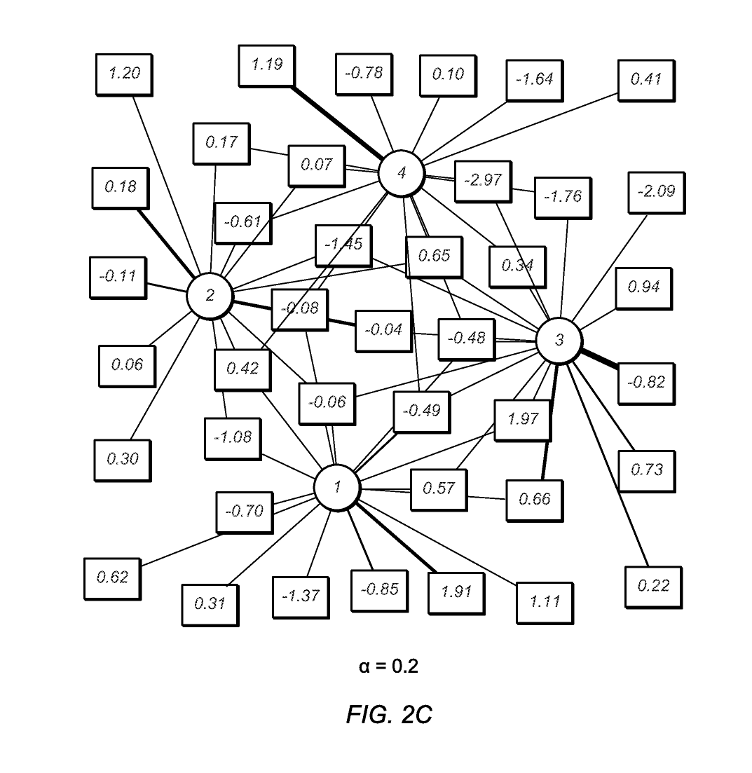

FIG. 2 gives examples of synthetic W matrices generated for different values of the sparsity parameter α. See Section 6.2 for a description of a and how W is generated. In the graphs shown, the rectangles are the question labels with their intrinsic difficulty. A link between a question and concept means that the questions tests knowledge on that concept. In general, a lower (higher) α corresponds to a sparser (denser) W matrix.

6.1 Simulation Setup

Generating synthetic W: To generate a matrix W, we assume that most of the questions test knowledge from only one knowledge component and only some questions test knowledge from multiple knowledge components. With this structure of the questions in mind, we generate W as follows:

Partition the questions into Q/K groups and map each group to a different knowledge component. The strength of the mapping, wᵢⱼ, is sampled independently from an exponential distribution with parameter λ=1.

Note that in the matrix W generated so far, Q(K−1) entries have not yet been assigned. We randomly choose a fraction α of these entries and assign them to non-zero values sampled from an exponential distribution with parameter λ=1. In what follows, we refer to α as the sparsity parameter.

In the generation of W so far, suppose the first question maps to two knowledge components, say 1 and 2, and the second question maps only to 1. If w_{1,1}=w_{2,1}, then for a learner with knowledge component parameter c*, we have w₁^{T}c*>w₂^{T}c*. This means that, just because the first question tests knowledge from more than one concept, a learner is more likely to get that question correct. To avoid such a situation, the final step in generating W is a normalization so that each row in W is divided by the number of non-zero entries in that row.

Three examples of matrices W generated using the above approach are visualized in FIG. 2 for different values of the sparsity parameter α.

Performance measures: We use three measures to assess the performance of TeSR:

(1) The root mean-square error (RMSE) for the knowledge component estimate, defined as RMSE_{c}=∥ĉ−c*∥₂/\sqrt{K}, where ĉ is the estimate delivered by each method and c* is the (known) ground truth.

(2) The RMSE for the ability parameter, RMSEₐ=|â−a*|, where â is the estimate delivered by each method and a* is the (known) ground truth.

(3) The negative log-likelihood (NLL) over a hold-out set of questions H

$$NLL = - {\sum }_{i ∈ H} ( {y}_{i} ( {w}_{i}^{T} \hat{c} + \hat{a} + {μ}_{i} ) - log ( 1 + exp ( {w}_{i}^{T} \hat{c} + \hat{a} + {μ}_{i} ) ) ,$$

where ĉ and â are the estimates generated by the TeSR method under consideration. The set H is randomly chosen in each trial from the set of all questions Q.

For synthetic data, we only use the RMSE, since the ground truth parameters, c* and a*, are known. For real data, we use both the RMSE and the NLL. Since the ground truth for real data is, in general, unknown, we approximate the RMSE based measures by assuming that the ground truth corresponds to the parameters estimated from all Q available questions. Note that the NLL does not require knowledge about the ground truth. Evidently, we want all the performance measures to be as small as possible.

Methodology: In all the experiments, we assume that W and are known. This is specified for the synthetic data and estimated using all Q questions for the real data using a properly modified version of the SPARFA-M algorithm from (Lan et al., 2014) that takes into account the ability parameter in the eSPARFA model. For synthetic experiments, the parameters of a learner, namely the knowledge component and ability parameter, are sampled from a uniform distribution on the closed interval [−1, 1]. Further, as shown in Section 3, the TeSR algorithms use prior learner response data \tilde{Y} to approximate the TeSR objective function. In all simulations, we obtain a matrix of student response data Y of size Q×(N+1) from (N+1) learners answering Q questions. We arbitrary subsample the response \tilde{Y} matrix of size Q×N from Y and then apply the TeSR methods to design a test for the left out learner. In all simulations, we let N=50, and we report the mean and standard deviation of the performance measures computed over 1000 trails.

MLE convergence: As mentioned in Section 3, the MLE may not exist for certain patterns of the response vectors. In such cases, â and the entries in ĉ are either set to +∞ or −∞. To deal with such situations and with situations where the entries are too large (or small), we truncate the learner parameters as follows:

$$\hat{a} = \{ \begin{matrix}min \{ \hat{a} , {a}^{+} \} & \hat{a} \geq 0 \\ max \{ \hat{a} , {a}^{-} \} & \hat{a} < 0\end{matrix} \\ {\hat{c}}_{i} = \{ \begin{matrix}min \{ {\hat{c}}_{i} , {c}_{i}^{+} \} & {\hat{c}}_{i} \geq 0 \\ max \{ {\hat{c}}_{i} , {c}_{i}^{-} \} & {\hat{c}}_{i} < 0\end{matrix} , i = 1 , … , K ,$$

where a⁺, a⁻, c⁺ and c⁻ are computed using the prior response data \tilde{Y}. For example, a⁺ (a⁻) is the maximum (minimum) ability parameter among the N learners in the training data. Furthermore, we assume that a⁺≧0 and a⁻<0. The entries in the vectors c⁺ and c⁻ are defined in a similar manner. The intuition behind the above truncation is that if a parameter is estimated to be too large (or small), then it is reasonable to estimate that parameter to the best (worst) value obtained among a group of learners who have previously answered questions on the same topic.

6.2 NA-TeSR Experiments

We now show empirical results on synthetic data comparing the NA-TeSR method detailed in Algorithm 1 to three other TeSR methods:

EV: Recall from Section 3 that NA-TeSR uses prior data to approximate the TeSR objective function by using an estimate of the variance Var[Yᵢ|wᵢ,c*,a*]. The EV method, short for equal variance, assumes that the variance of each question is the same, i.e, Var[Yᵢ|wᵢ,c*,a*]=Var[Y_{i′}|w_{i′},c*,a*]=v with v>0 for all i,i′=1, . . . , Q. EV is implemented by simply using using the approximation \tilde{v}ᵢᵢ=v in Algorithm 1.

NA-Rasch: The NA-Rasch method ignores the question-knowledge component matrix W in Algorithm 1 so that the selected questions Ĩ maximize

$${\sum }_{i ∈ \tilde{I}} {\tilde{v}}_{ii} ,$$

where \tilde{v}ᵢᵢ is the approximation (7). This is equivalent to assuming that the data is being generated from a Rasch model with the difficulty of questions set to μ, or equivalently, corresponding to the eSPARFA model with K=0.
Greedy: The Greedy method iteratively selects a question at random from each concept until the required number of questions has been selected. If all questions from a given concept are exhausted, then Greedy ignores the questions from that knowledge component in subsequent iterations. This method may be considered a straightforward approach adopted by course instructors or domain experts when designing questions.

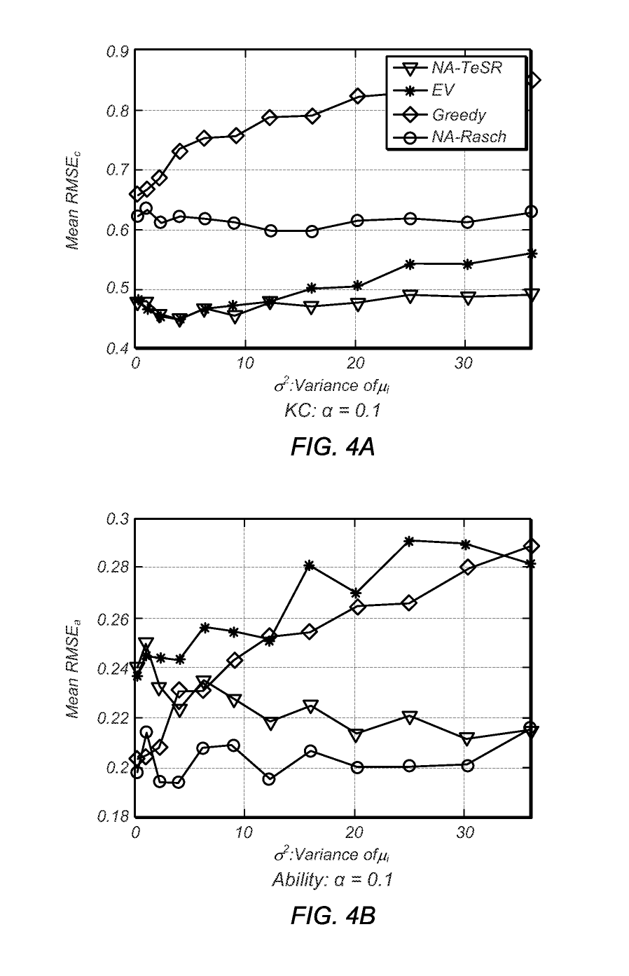

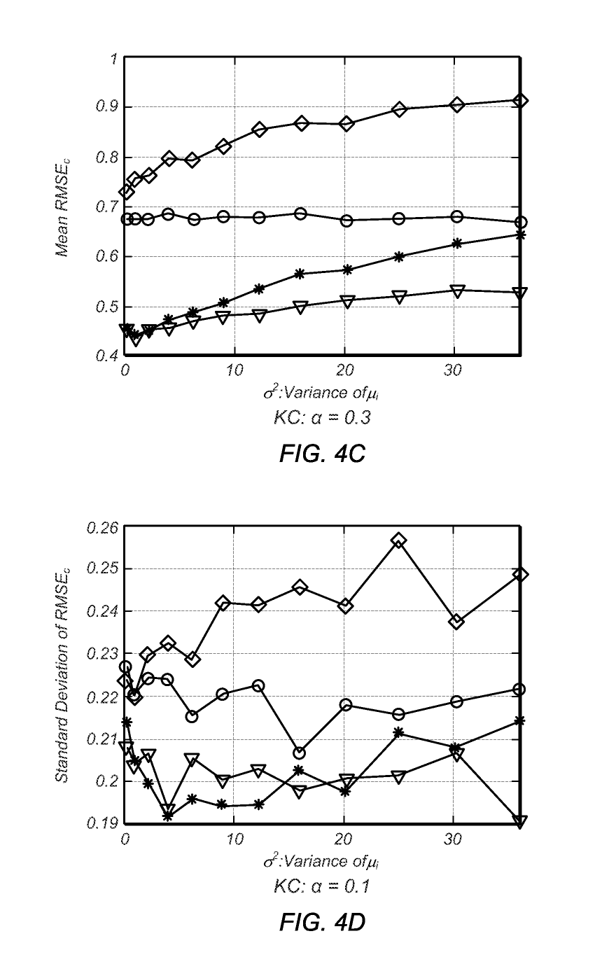

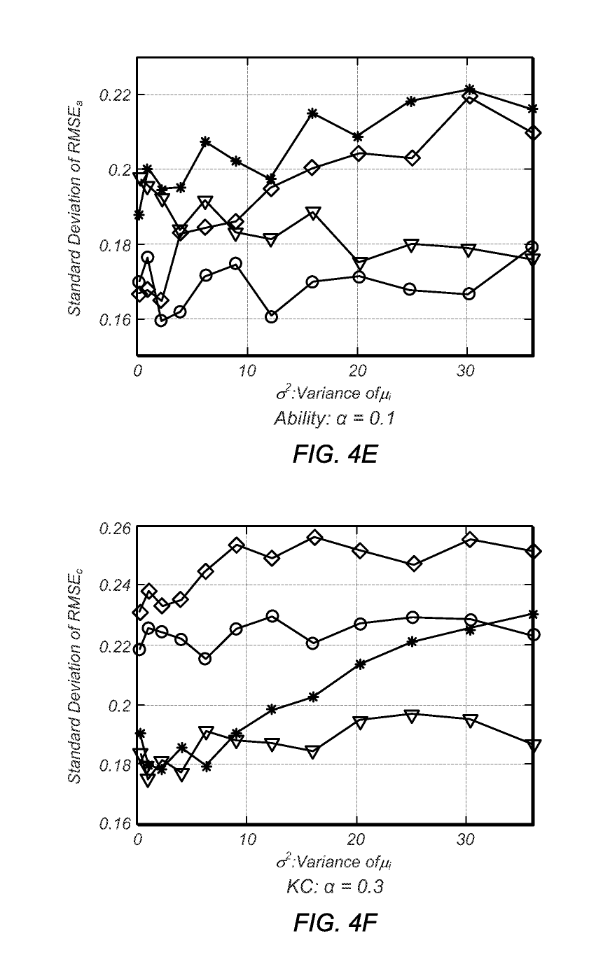

To generate synthetic data, in each trial of the experiments, we sample the learner parameters and W as described in Section 6.2 with Q=400. The intrinsic difficulty of each question, μᵢ, is sampled from a Gaussian distribution with mean 0 and variance σ². FIG. 4 plots the mean and standard deviation of the RMSE based performance measures as the number of selected questions varies from 20 to 100 and σ²=25.0. FIG. 4 plots the mean and standard deviation of the RMSE based performance measures as the variance σ² varies from 0.5 to 36.0 and q=40. Some remarks regarding the results are as follows:

The Greedy method performs worse than NA-TeSR in estimating both c* and a*. This shows that the TeSR problem formulation of minimizing the uncertainly in the estimation of the learner parameters is appropriate for designing small and accurate tests.

Although the NA-Rasch method, in general, leads to good estimates of a* (when compared to other methods), its estimates of c* are, in general, worse than both EV and NA-TeSR. This demonstrates that when questions test knowledge from multiple concepts, the relationship between the questions and the concepts should not be ignored when designing tests.

The EV method is the most competitive to our proposed NA-TeSR method for estimating c*. In particular, we see in FIG. 4 that for small σ² (the variance of μᵢ), both EV and NA-TeSR yield comparable estimates of c*. However, as σ² increases, NA-TeSR performs substantially better than EV in terms of estimating the knowledge component parameter. The reason for this is that, when σ² is small, the difficulties of the questions are likely to be similar. In this case, the variance in answering a question correctly, Var[Yᵢ|wᵢ, c*, a*], is more likely to be similar to the variance of other questions. This validates the EV approximation when σ² is small, where all the variances are assumed to be the same.

The EV method performs the worst when it comes to estimating a*. Thus, although EV is suitable for designing tests for estimating the knowledge component parameters when σ² is small, EV is not appropriate for estimating the ability parameters.

FIG. 4 highlights an additional benefit of NA-TeSR: it enables us to rank questions in order of their importance in assessing mastery of learner parameters. To this end, one can use NA-TeSR with q=Q to obtain an ordering of questions with the property that the error in estimating the learner parameters decreases as the learner answers the questions in a sequential manner from the ordered list of questions. Such an ordering can be useful in identifying questions, mainly towards the end of the order, that are only marginally important in assessing the concept knowledge and ability of learners. Such questions can either be omitted or revised by an instructor or domain expert.

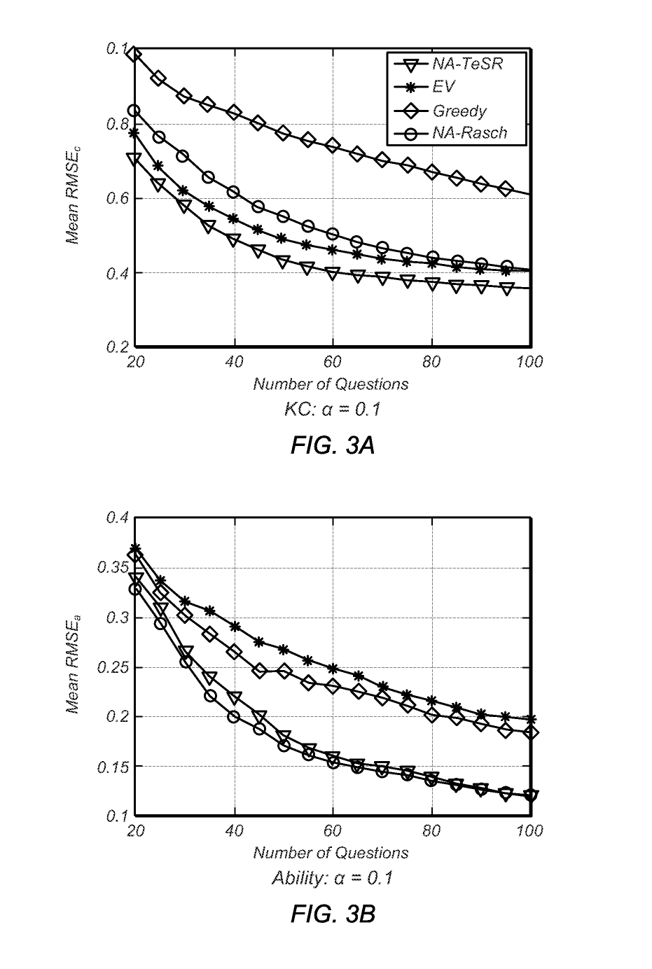

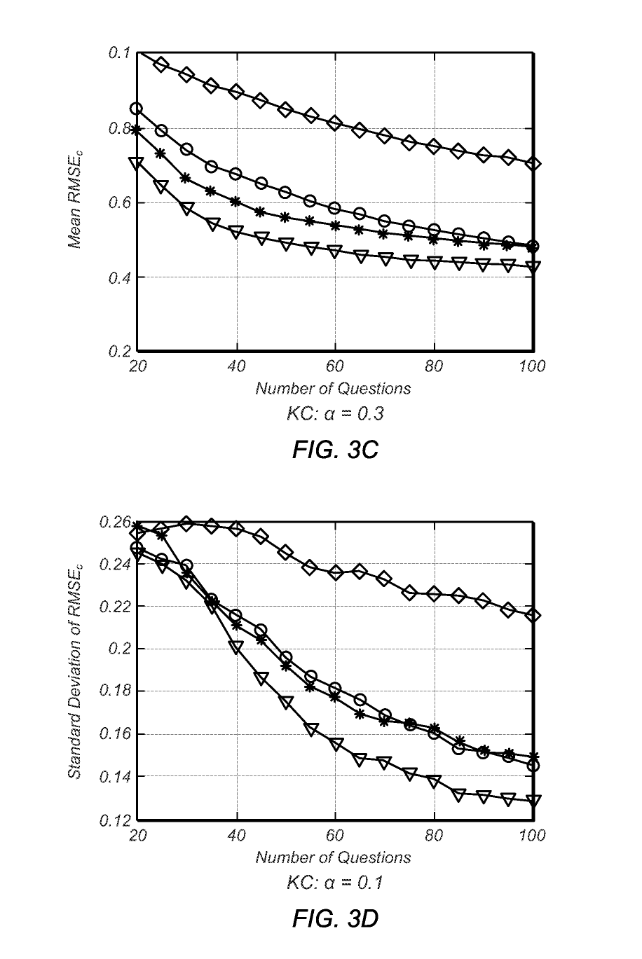

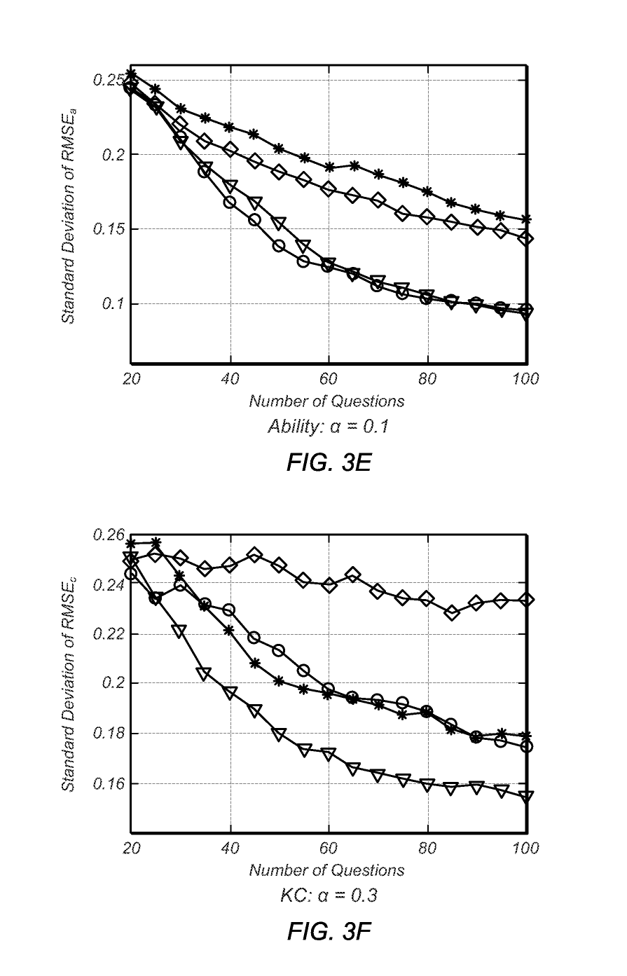

FIGS. 3A-3F illustrate mean and standard deviation of the RMSE-based performance measures as the number of questions selected varies from 20 to 100; “KC” refers to the knowledge component parameters, and “Ability” refers to the ability parameter.

FIGS. 4A-4F illustrates mean and standard deviation of the RMSE-based performance measures as variance of the intrinsic difficulty varies from 0.25 to 36.0.

6.3 A-TeSR Experiments

We now show the benefits of the adaptive TeSR method, A-TeSR, for designing tests. In addition to comparing A-TeSR to NA-TeSR, we also compare the following two methods:

A-Rasch: The A-Rasch method uses the Rasch model to select questions in an adaptive manner based on the prior responses from a learner. We implement A-Rasch using Algorithm 2 with K=0.

Oracle: The Oracle method uses the true underlying (but in practice unknown) knowledge component vector c* and ability parameter a* to compute the TeSR objective, and uses Algorithm 2 to select questions. Note that this algorithm is not practical and is only used to characterize the performance limits of A-TeSR.

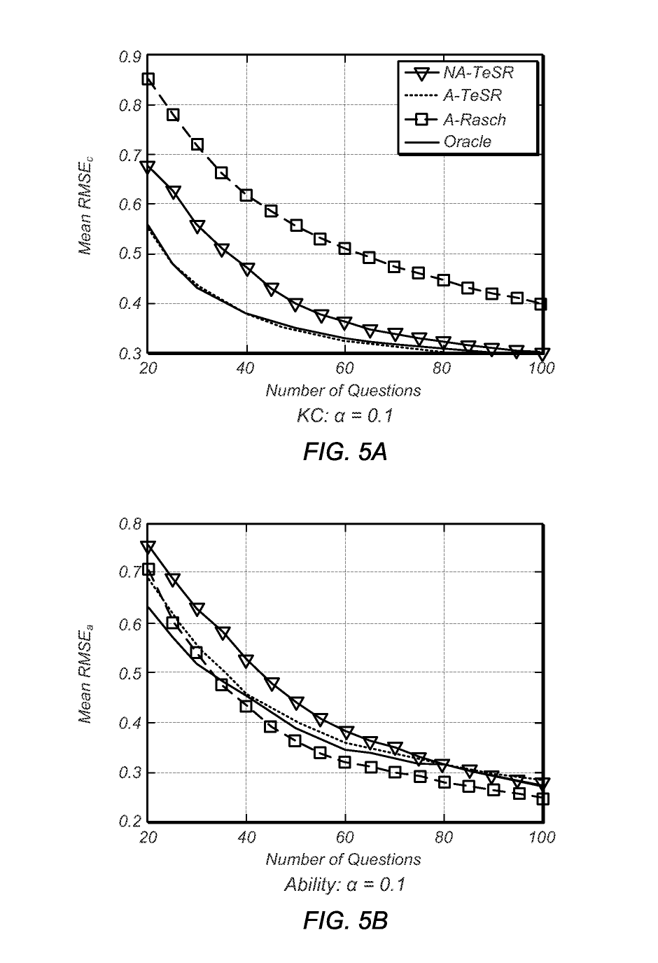

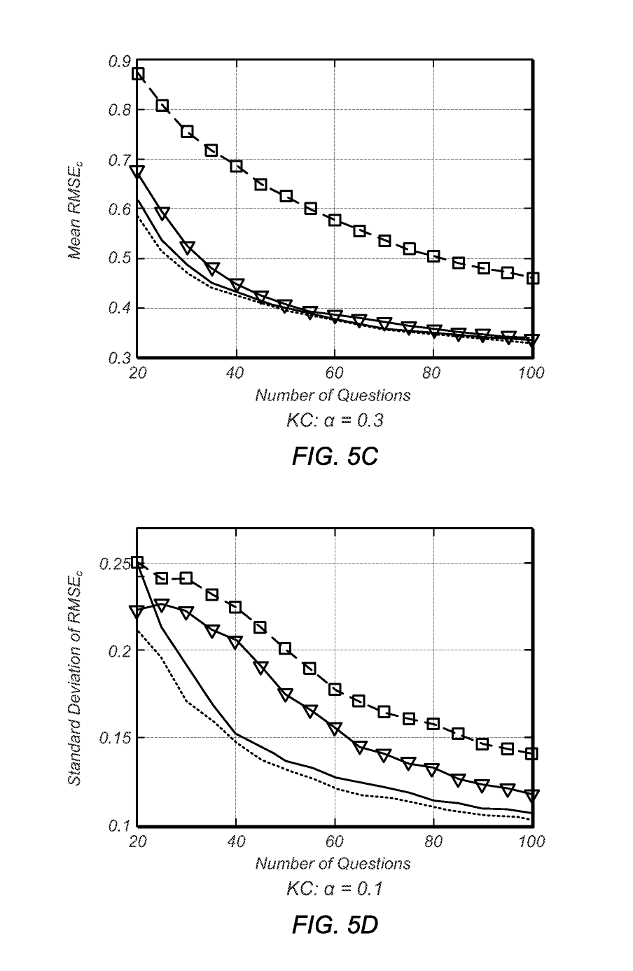

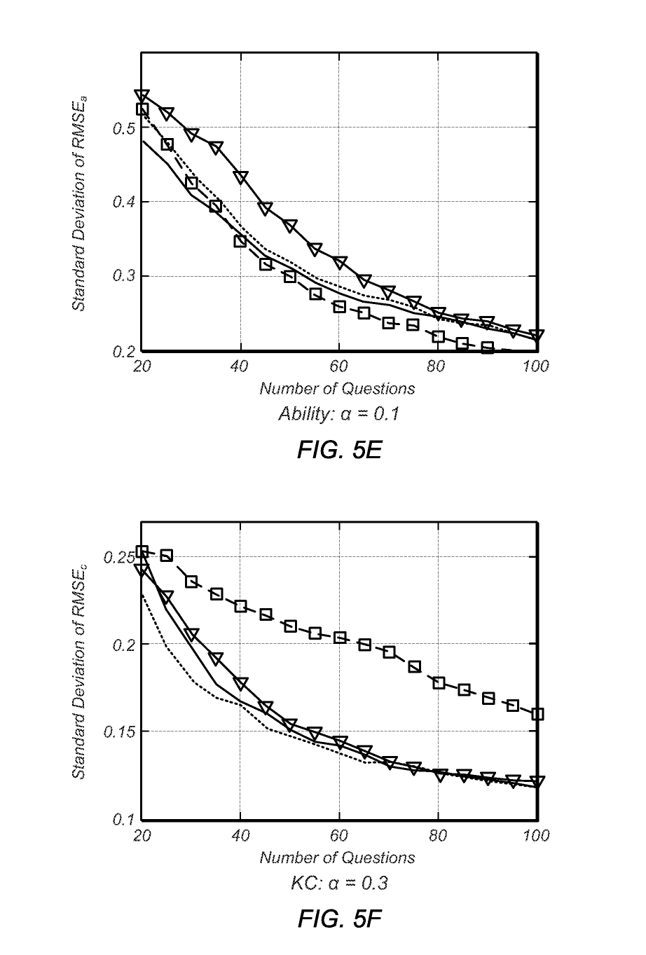

FIGS. 5A-5F compare the RMSE based performance measures as the number of questions vary from 20 to 100 with σ²=4.0 (the variance of the difficulty μᵢ). The rest of the simulation setup is the same as in Section 6.2. To avoid clutter in the presentation of the results, we do not present results for the ability parameter when α=0.3, but note that the results are similar to that of α=0.1, where recall that a is the sparsity parameter that controls the number of non-zero entries in the question-knowledge component matrix W. Furthermore, we do not present results comparing A-TeSR to the other non-adaptive methods outlined in Section 6.2, since NA-TeSR was shown to be superior to all other non-adaptive methods. Some remarks regarding the results are as follows:
A-TeSR outperforms all other methods for estimating the knowledge component parameters. Somewhat surprisingly, A-TeSR's performance in estimating the knowledge component parameter is similar to, and in some cases slightly better, than the Oracle method. The reason for this is that the Oracle method is designed to jointly minimize the error of both the knowledge component and the ability parameter, i.e., the error

∥ĉ−c*|₂²+|â−a*|²,

while FIG. 5A only shows the error from the knowledge component parameter.
Although the Rasch model based method, A-Rasch, leads to superior results for estimating the ability parameter, it is significantly worse than the A-TeSR method when estimating the knowledge component parameter. Just as in the non-adaptive setting, this shows that using the Rasch model for adaptive testing is not suitable when the questions test knowledge on multiple concepts.
Comparing FIG. 5A and FIG. 5C, we see that the performance of NA-TeSR is closer to the performance of A-TeSR when α is larger; recall that larger α corresponds to a matrix W that is more dense. This behavior suggests that the advantage of using adaptive testing is more significant when there are a smaller number of interactions among the knowledge components. This advantage of A-TeSR can be attributed to the fact that, when W is sparse, the MLE is less likely to exist for a small number of questions. Thus, since A-TeSR adaptively selects questions using Theorem 2 so that the MLE can be computed in as few number of questions as possible, its performance is superior to NA-TeSR for smaller number of questions. As the sparsity of W increases, the MLE is more likely to exist for smaller number of questions, and so the performance of NA-TeSR becomes closer to the performance of A-TeSR.

6.4 Real Educational Data

To assess the performance of the proposed TeSR algorithms under realistic conditions, we carried out experiments using two real educational datasets. The datasets were obtained from exams conducted by a university for admission into their undergraduate program; the learners in these datasets are high-school students. We analyze the data from the exam conducted in 2011 and 2012. Both tests consist of Q=60 questions testing knowledge on physics, chemistry, mathematics, and biology. The exams were graded by negative marking, where a correct response lead to +3 points, no response lead to 0 points, and an incorrect response lead to −1 points. For this reason, some learners did not respond to all questions intentionally. In order to fit the data to the eSPARFA model, we treat unanswered questions as missing responses. Note that a more accurate statistical model for this dataset would also model the probability of a learner not answering a question.

For the 2011 data, there are 1714 learners, and for the 2012 data, there are 1567 learners. For both datasets, we use all the data to obtain estimates of W and μ. In this case, we make use of the tags in each question (i.e., physics, chemistry, mathematics, and biology) to further improve the performance of the SPARFA-M algorithm as described in (Lan et al., 2013). Not surprisingly, the estimated W matrix maps each question to a single knowledge component.

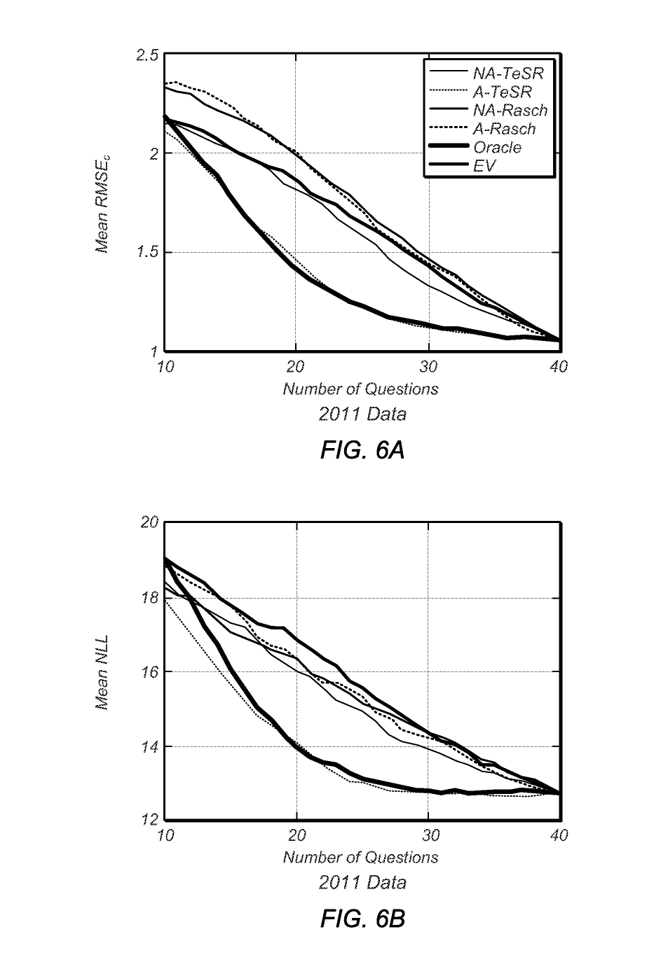

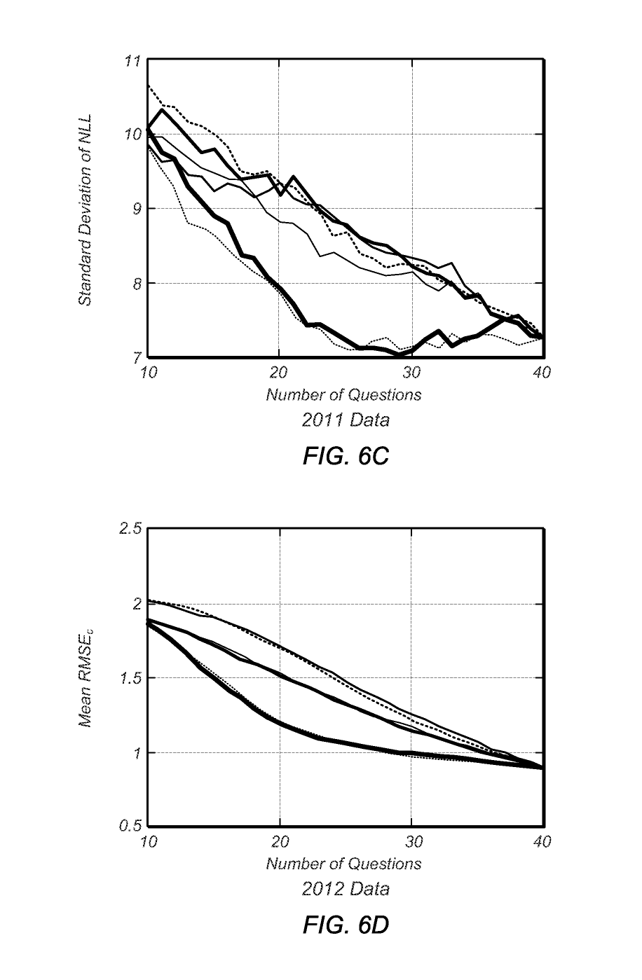

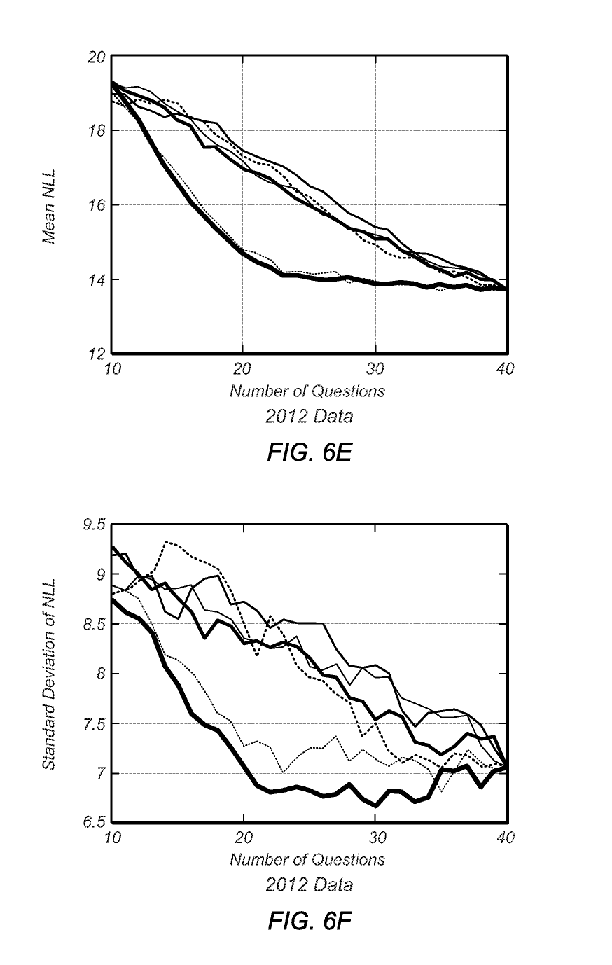

In each trial of the simulation, we randomly select N=50 learners to obtain the prior learning data (used to approximate the TeSR objective), arbitrary select another learner to test the TeSR methods, and select 20 questions to compute the negative log-likelihood (NLL). FIGS. 6A-6F plot the mean of the knowledge component RMSE and the mean and the standard deviation of the NLL over 1000 trials for different TeSR methods. To improve readability of the plots, we do not show the results from the Greedy method (the performance was similar to or worse than Rasch model-based methods). Further, as mentioned earlier, the ground truth for the RMSE and the oracle method is computed using all the available Q=60 questions.

The conclusions drawn from FIGS. 6A-6F are the same as the conclusions drawn from the synthetic data results. In particular, (i) A-TeSR performs significantly better than all other algorithms, (ii) NA-TeSR performs better than the Rasch-based algorithms, and (iii) A-TeSR performs as good as, and sometimes better than the Oracle method. For example, in the 2011 data, A-TeSR achieves a mean NLL of 14 using approximately 20 questions, whereas all other methods require more than 30 questions to achieve the same NLL.

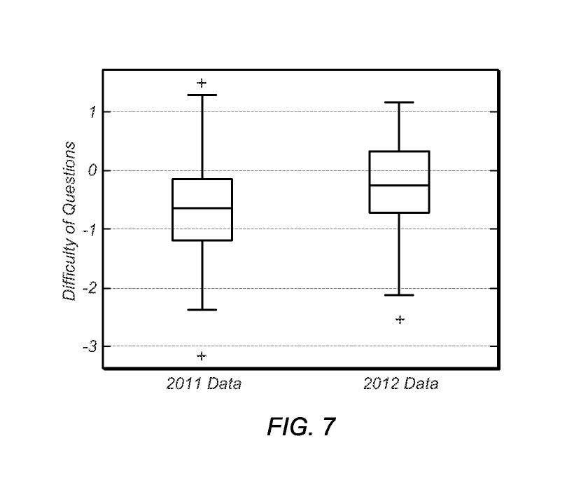

One particularly interesting aspect of the results is the difference between the performance of NA-TeSR and EV in both data sets. In particular, although NA-TeSR outperforms EV for the 2011 data, the performance of NA-TeSR and EV are nearly the same for the 2012 data. The reason for this can mainly be addressed to the difference in the difficulty of the questions in the 2011 and 2012 data. To illustrate this difference, FIG. 7 shows a box plot of the intrinsic difficulty parameters for both data sets. We clearly see that the difficulty parameters for the 2011 data have a wider range than the difficulty parameters for the 2012 data. This implies that the variance of a learner's responses to questions is more likely to be similar for the 2012 data than for the 2011 data. We saw in Section 6.2, this is the main reason why the performance of EV is nearly the same as that of NA-TeSR.

7 Review

We propose among other things two novel methods for test-size reduction (TeSR) that aim to design efficient (small) and accurate tests. Given a question bank containing a large number of questions, TeSR selects a small number of questions such that the selected questions can accurately assess learners. One natural application of TeSR is in designing tests for assessing the knowledge understanding of learners in a course. Yet another application of TeSR is in designing psychological tests. Our methods for solving the TeSR problem use an extended version of the SPARse Factor Analysis (SPARFA) framework proposed in (Lan et al., 2014) to model the relationship between questions and concepts in a course. Subsequently, using the theory of maximum likelihood estimators for logistic regression, we formulate the TeSR problem as that of minimizing the uncertainty in the asymptotic error of estimating the concept understanding.

Our first proposed method for TeSR, referred to as non-adaptive TeSR (NA-TeSR), uses a data-driven approach to select questions to approximately solve a combinatorial optimization problem in a greedy manner. This approach is suitable in settings where an instructor only has access to the learners' responses once all questions have been solved. Our second proposed method, referred to as adaptive TeSR (A-TeSR), is an adaptive algorithm that iteratively suggests questions for each learner individually based on graded responses of learners to prior questions. Our extensive experimental results show that NA-TeSR and A-TeSR significantly outperform state-of-the-art methods that use the well-established Rasch model (Rasch, 1960). Experimental results on real educational datasets have shown that TeSR can reduce the number of questions needed in a test/assessment by 40%, which significantly reduces learners' workload while still being able to obtain accurate estimates of each learner's concept knowledge.

In some embodiments, our criterion for selecting questions, is both the non-adaptive and the adaptive methods, is based on the Fisher information. Alternative criteria based on Bayesian methods (van der Linden, 1998) and the Kullback-Liebler divergence (Wang et al., 2011) have been proposed in the literature. The framework set forth in this patent disclosure can be easily adapted to other methods.

While formulating the TeSR problem and developing the proposed algorithms in the present disclosure, we primarily focus on the case where the learner responses are binary, i.e, either correct (1) or incorrect (0). However, it should be understood that responses can be on an ordinal scale. For example, in educational settings, even if a response is incorrect, a learner may obtain partial credit for showing some understanding of the concepts. The SPARFA model has been extended to handle ordinal data in (Lan et al., 2013). Similar methods can be used for the proposed eSPARFA framework. Thus, the TeSR problem can be formulated with respect to the Fisher information of the ordinal model.

Furthermore, we present TeSR in the context of selecting q questions out of a database of Q questions. However, by choosing q=Q in the TeSR methods, we can easily output a ranked list of questions such that if question i is ranked higher than question j, then question i is deemed more important/suitable for assessing the knowledge understanding of learners. Such a list can help instructors visualize a ranking of all questions and then select a suitable subset of questions or revise questions that have been ranked low. We note that a ranking of questions can also be useful when applying TeSR to psychological tests, where, a question ranked higher corresponds a question being more suitable for understanding certain aspects of human behavior.

### REFERENCES

T. A. Ackerman. 1994. Using multidimensional item response theory to understand what items and tests are measuring. Applied Measurement in Education 7, 4 (1994), 255-278.
A. Albert and J. A. Anderson. 1984. On the existence of maximum likelihood estimates in logistic regression models. Biometrika 71, 1 (April 1984), 1-10.
A. Anastasi and S. Urbina. 1997. Psychological testing. Prentice Hall New Jersey.
J. R. Anderson, C. F. Boyle, and B. J. Reiser. 1982. Intelligent Tutoring Systems. Science 228, 4698 (1982), 456-462.
F. B. Baker and S. H. Kim. 2004. Item Response Theory: Parameter Estimation Techniques (2nd ed.). Marcel Dekkker Inc.
R. S. J. D. Baker, A. T. Corbett, and V. Aleven. 2008. More accurate student modeling through contextual estimation of slip and guess probabilities in bayesian knowledge tracing. In Intelligent Tutoring Systems, Vol. 5091. Springer, 406-415.
T. Barnes. 2005. The Q-matrix Method: Mining Student Response Data for Knowledge. In Proc. American Association for Artificial Intelligence Workshop on Educational Data Mining.
D. Benson. 2008. Actively Modifying The Classroom Approach Using Pre-Tests And Recurring Problems. In American Society for Engineering Education Annual Conf. and Exposition.
Y. Bergner, S. Droschler, G. Kortemeyer, S. Rayyan, D. Seaton, and D. Pritchard. 2012. Model-Based Collaborative Filtering Analysis of Student Response Data: Machine-Learning Item Response Theory. In Proc. of the 5th Intl. Conf. on Educational Data Mining. 95-102.
S. Boyd and L. Vandenberghe. 2004. Convex Optimization. Cambridge University Press. P. Brusilovsky and C. Peylo. 2003. Adaptive and Intelligent Web-based Educational Systems. Intl. Journal of Artificial Intelligence in Education 13, 2-4 (April 2003), 159-172.
S. Buyske. 2005. Optimal design in educational testing. Applied Optimal Designs (2005), 1-19.
H. Cen, K. R. Koedinger, and B. Junker. 2006. Learning Factors Analysis—A General Method for Cognitive Model Evaluation and Improvement. In Intelligent Tutoring Systems. Lecture Notes in Computer Science, Vol. 4053. Springer, 164-175.
H. Chang and Z. Ying. 1996. A global information approach to computerized adaptive testing. Applied Psychological Measurement 20, 3 (September 1996), 213-229.
H. Chang and Z. Ying. 2009. Nonlinear Sequential Designs for Logistic Item Response Theory Models with Applications to Computerized Adaptive Tests. The Annals of Statistics 37, 3 (June 2009), 1466-1488.
M. Chi, K. Koedinger, G. Gordon, and P. Jordan. 2011. Instructional factors analysis: A cognitive model for multiple instructional interventions. In Proc. 4th Intl. Conf. on EDM. 61-70.
A. T. Corbett and J. R. Anderson. 1994. Knowledge tracing: Modeling the acquisition of procedural knowledge. User modeling and user-adapted interaction 4, 4 (December 1994), 253-278.
T. M. Cover and J. A. Thomas. 2012. Elements of Information Theory. John Wiley & Sons.
M. Desmarais. 2011. Conditions for Effectively Deriving a Q-Matrix from Data with Non-negative Matrix Factorization. In Proc. 4th Intl. Conf. on Educational Data Mining. 41-50.
L. Fahrmeir and H. Kaufmann. 1985. Consistency and asymptotic normality of the maximum likelihood estimator in generalized linear models. The Annals of Statistics 13, 1 (March 1985), 342-368.
M. Feng and N. T. Heffernan. 2006. Informing teachers live about student learning: Reporting in the ASSISTment system. Technology Instruction Cognition and Learning 3, 1/2 (2006), 63.
K. Fronczyk, A. E. Waters, M. Vannucci, M. Guindani, and R. G. Baraniuk. 2013. A Bayesian infinite factor model for learning and content analytics. Submitted to Computational Statistics and Data Analysis (2013).
U. GraBhoff, H. Holling, and R. Schwabe. 2012. Optimal Designs for the Rasch Model. Psychometrika 77, 4 (October 2012), 710-723.
H. H. Harman. 1976. Modern Factor Analysis. The University of Chicago Press.
J. Hartley and I. K. Davies. 1976. Preinstructional Strategies: The Role of Pretests, Behavioral Objectives, Overviews and Advance Organizers. Review of Educational Research 46, 2 (January 1976), 239-265.
G. Hooker, M. Finkelman, and A. Schwartzman. 2009. Paradoxical results in multidimensional item response theory. Psychometrika 74, 3 (September 2009), 419-442.
P. Jordan and M. Spiess. 2012. Generalizations of paradoxical results in multidimensional item response theory. Psychometrika 77, 1 (January 2012), 127-152.
S. Joshi and S. Boyd. 2009. Sensor selection via convex optimization. IEEE Trans. on Signal Processing 57, 2 (February 2009), 451-462.
J. Knox, S. Bayne, H. MacLeod, J. Ross, and C. Sinclair. 2012. MOOC pedagogy: the challenges of developing for Coursera. Online Newsletter of the Association for Learning Technologies (August 2012). Issue 28.
K. R. Koedinger, E. A. McLaughlin, and J. C. Stamper. 2012. Automated Student Model Improvement. In Proc. 5th Intl. Conf. on EDM. 17-24.
K. Konis. 2007. Linear Programming Algorithms for Detecting Separated Data in Binary Logistic Regression Models. Ph.D. Dissertation. Oxford University.
I. G. G. Kreft and J. de Leeuw. 1998. Introducing Multilevel Modeling. Sage.
A. S. Lan, A. E. Waters, C. Studer, and R. G. Baraniuk. 2013. Tag Aware Ordinal Sparse Factor Analysis for Learning and Content Analytics. In Proc. 6th Intl. Conf. on Educational Data Mining.
A. S. Lan, A. E. Waters, C. Studer, and R. G. Baraniuk. 2014. Sparse Factor Analysis for Learning and Content Analytics. to appear in Journal of Machine Learning Research (2014).
E. Loken, F. Radlinski, V. H. Crespi, J. Millet, and L. Cushing 2004. Online study behavior of 100,000 students preparing for the SAT, ACT, and GRE. Journal of Educational Computing Research 30, 3 (May 2004), 255-262.
F. M. Lord. 1980. Applications of Item Response Theory to Practical Testing Problems. Erlbaum Associates.
R. M. Luecht. 1996. Multidimensional computerized adaptive testing in a certification or licensure context. Applied Psychological Measurement 20, 4 (December 1996), 389-404.
F. G. Martin. 2012. Will massive open online courses change how we teach? Commun. ACM 55, 8 (August 2012), 26-28.
Z. A. Pardos and N. T. Heffernan. 2011. KT-IDEM: introducing item difficulty to the knowledge tracing model. In User Modeling, Adaption and Personalization. Vol. 6787. Springer, 243-254.
G. Rasch. 1960. Probabilistic Models for Some Intelligence and Attainment Tests. Danmarks paedagogiske Institut.
M. D. Reckase. 2009. Multidimensional Item Response Theory. Springer.
S. Ritter, J. Anderson, M. Cytrynowicz, and O. Medvedeva. 1998. Authoring content in the PAT algebra tutor. Journal of Interactive Media in Education 98, 9 (October 1998).
D. O. Segall. 1996. Multidimensional adaptive testing. Psychometrika 61, 2 (June 1996), 331-354.
M. Shamaiah, S. Banerjee, and H. Vikalo. 2010. Greedy sensor selection: Leveraging submodularity. In Proc. of 49th IEEE Conf. on Decision and Control. 2572-2577.
J. C. Stamper, T. Barnes, and M. Croy. 2007. Extracting Student Models for Intelligent Tutoring Systems. In Proc. of the National Conf. on Artificial Intelligence, Vol. 22.113-147.
J. L. Templin and R. A. Henson. 2006. Measurement of psychological disorders using cognitive diagnosis models. Psychological Methods 11, 3 (September 2006), 287.
N. Thai-Nghe, L. Drumond, T. Horvath, and L. Schmidt-Thieme. 2011. Multi-relational Factorization Models for Predicting Student Performance. KDD 2011 Workshop on Knowledge Discovery in Educational Data (August 2011).
W. J. van der Linden. 1998. Bayesian item selection criteria for adaptive testing. Psychometrika 63, 2 (June 1998), 201-216.
W. J. van der Linden and C. A. W. Glas. 2000. Computerized Adaptive Testing: Theory and Practice. Springer.
W. J. van der Linden and P. J. Pashley. 2010. Item Selection and Ability Estimation in Adaptive Testing. In Elements of Adaptive Testing. Springer New York, 3-30.
K. VanLehn, C. Lynch, K. Schulze, J. A. Shapiro, R. Shelby, L. Taylor, D. Treacy, A. Weinstein, and M. Wintersgill. 2005. The Andes Physics Tutoring System: Lessons Learned. Intl. Journal of Artificial Intelligence in Education 15, 3 (2005), 147-204.
C. Wang, H. Chang, and K. A. Boughton. 2011. Kullback-Leibler information and its applications in multi-dimensional adaptive testing. Psychometrika 76, 1 (January 2011), 13-39.
G. Wiggins. 1998. Educative Assessment: Designing Assessments To Inform and Improve Student Performance. ERIC.

### Non-Adaptive Test Size Reduction Method

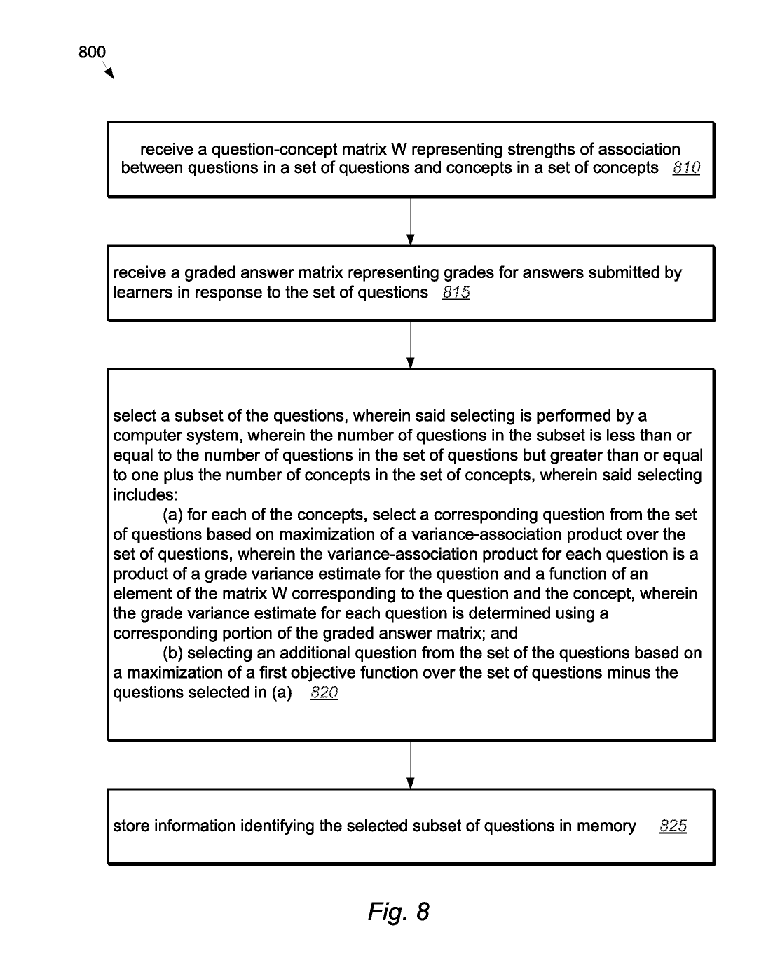

In one set of embodiments, a method 800 may include the operations shown in FIG. 8. (The method 800 may also include any subset of the features, elements and embodiments described above.) The method 800 may be used to select a subset of questions from a set (or database) of questions. It should be understood that various embodiments of method 800 are contemplated, e.g., embodiments in which the illustrated operations are performed in different orders, embodiments in which one or more of the illustrated operations are omitted, embodiments in which the illustrated operations are augmented with one or more additional operations, embodiments in which one or more of the illustrated operations are parallelized, etc. The method 800 may be implemented by a computer system (or more generally, by a set of one or more computer systems). In some embodiments, the computer system may be operated by an educational service provider, e.g., an Internet-based educational service provider.

At 810, the computer system may receive a question-concept matrix W representing strengths of association between questions in a set of questions and concepts in a set of concepts.

At 815, the computer system may receive a graded answer matrix representing grades for answers submitted by learners in response to the set of questions. In some embodiments, the grades may be binary grades. In other embodiments, the grades may be ordinal grades. In yet other embodiments, the grades may be real-valued grades.

At 820, the computer system may select a subset of the questions, where the number of questions in the subset is less than or equal to the number of questions in the set of questions but greater than or equal to one plus the number of concepts in the set of concepts. The action of selecting the subset of questions may include: (a) for each of the concepts, selecting a corresponding question from the set of questions based on maximization of a variance-association product over the set of questions, where the variance-association product for each question is a product of a grade variance estimate for the question and a function of an element of the matrix W corresponding to the question and the concept, where the grade variance estimate for each question is determined using a corresponding portion of the graded answer matrix; and (b) selecting an additional question from the set of the questions based on a maximization of a first objective function over the set of questions minus the questions selected in (a). For each question, the first objective function may be computed based on: a restriction of the question-concept matrix W corresponding to the question plus questions selected in (a), and, the grade variance estimates for the question and the questions selected in (a).

At 830, information identifying the selected subset of questions may be stored in memory. The selected subset of questions is configured to be administered to a new set of learners for testing knowledge of the new set of learners on the set of concepts.

In some embodiments, the selected subset of questions may be administered to the new set of learners, e.g., as part of a test. The action of administering the selected subset of questions may be performed by the above-described computer system or by one or more other computer systems. In some embodiments, the selected subset of questions may be administered to learners who access the computer system via the Internet using client computers.

In some embodiments, the selected subset of questions may be accessed by an instructor and used to generate a test to be administered to a new set of learners. For example, an instructor may operate a client computer to access the selected subset of questions from a server computer via the Internet. The server computer may generate a test including the selected subset of questions. The test generation may be performed, e.g., in response to a request asserted by the instructor's client computer. The server computer may transmit the test to the instructor's client computer, or make the test available to learners in response to a test administration request asserted by the instructor's client computer.

In some embodiments, the method 800 may also include displaying a visual representation of the selected subset of questions using a display device. For example, the visual representation may include a list of question numbers identifying the subset from the original set of questions, or a document including the text of the questions of the selected subset, or a graph including question nodes and concept nodes, where the question nodes correspond to the questions of the selected subset, where the concept nodes corresponds to the concept of said set of concepts.

In some embodiments, the method 800 may also include executing a sparse factor analysis algorithm to estimate an extent of concept understanding for each of the concepts based on grades for answers provided by the new set of learners in response to being administered the selected subset of questions.

In some embodiments, the number of questions in the subset is less than the number of questions in the set of questions.

In some embodiments, the number of questions in the subset is equal to the number of questions in the set of questions.

In some embodiments, the number q of questions in the subset is greater than one plus the number of concepts in the set of concepts. In these embodiments, the action of selecting the subset also includes: (c) one or more iterations of an induction operation. The induction operation may include selecting an (l+1)^{th} question for the subset based on a maximization of a second objective function over the set of questions minus the l questions already determined for the subset

For each question, the second objective function may be based on: (1) a restriction of the question-concept matrix W corresponding to the l already determined questions; (2) a row of the question concept matrix W corresponding to the question; and (3) the grade variance estimate corresponding to the question.

The operations (a), (b) and (c) define an ordering of the questions of the subset according to relevance (or usefulness) for testing the set of concepts. In the case where the number q of questions in the subset is equal to the number of questions in the set of questions (i.e., where the subset of questions equals the set of questions), the operations (a), (b) and (c) define a ranking of the set of questions according to relevance (or usefulness) for testing the set of concepts. The ranking allows instructors or practitioners to meaningfully organize their library of questions. In order to select questions for a test, an instructor may simply select any desired number of the top questions according to the ranking. For example, the instructor may select at least the top K+1 questions according to the ranking in order to guarantee an ability to estimate all K knowledge components.

In some embodiments, the matrix W is determined from an analysis of the graded answer matrix, e.g., using the extended SPARFA (eSPARFA) method described above or one of the SPARFA methods described in (Lan et al., 2013) or (Lan et al. 2014) or U.S. patent application Ser. No. 14/214,835 filed Mar. 15, 2014 or U.S. Provisional Application 61/790,727 filed Mar. 15, 2013.

In some embodiments, rows of the graded answer matrix correspond respectively to the questions in the set of questions, and columns of the graded answer matrix correspond respectively to the learners.

Adaptive Test Size Reduction Method

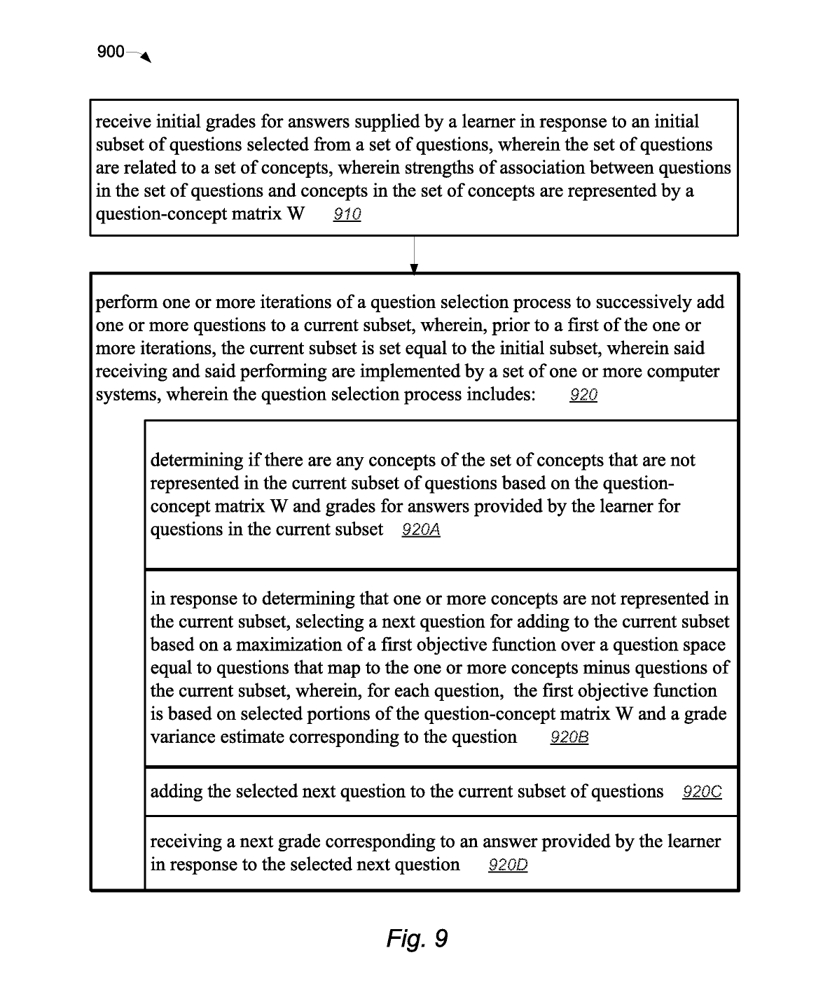

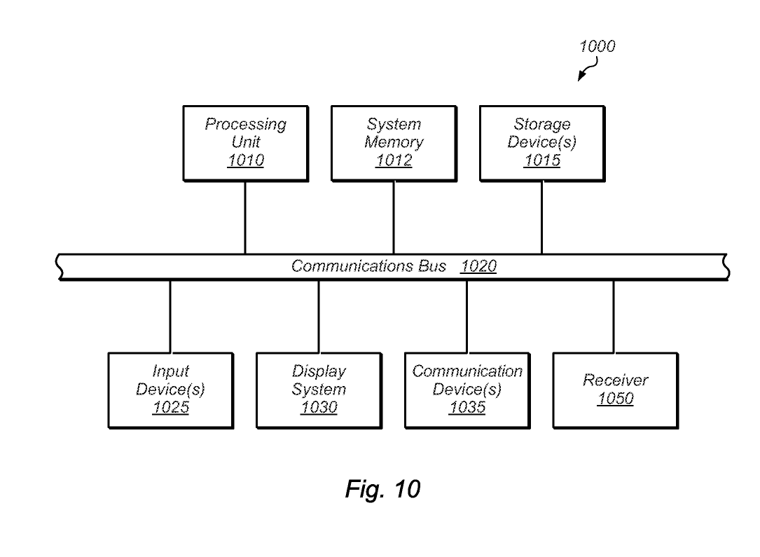

In one set of embodiments, a method 900 may include the operations shown in FIG. 9. (The method 900 may also include any subset of the features, elements and embodiments described above.) The method 900 may be used to test the concept knowledge of a learner or to adaptively select questions from a database of questions. It should be understood that various embodiments of method 900 are contemplated, e.g., embodiments in which the illustrated operations are performed in different orders, embodiments in which one or more of the illustrated operations are omitted, embodiments in which the illustrated operations are augmented with one or more additional operations, embodiments in which one or more of the illustrated operations are parallelized, etc. The method 900 may be implemented by a processing agent (e.g., by a computer system, or more generally, by a set of one or more computer systems). In some embodiments, the processing agent may be operated by an educational service provider, e.g., an Internet-based educational service provider.

At 910, the processing agent may receive initial grades for answers supplied by a learner in response to an initial subset of questions selected from a set of questions. The set of questions is related to a set of concepts, e.g., as variously described above. The number of questions in the initial subset is equal to at least one plus the number of concepts in the set of concepts. Strengths of association between questions in the set of questions and concepts in the set of concepts are represented by a question-concept matrix W.

At 920, the processing agent may perform one or more iterations of a question selection process to successively add one or more questions to a current subset. Prior to a first of the one or more iterations, the current subset may be set equal to the initial subset. The question selection process may include operations 920A through 920D as follows.

At 920A, the processing agent may determine if there are any concepts of the set of concepts that are not represented in the current subset of questions based on the question-concept matrix W and grades for answers provided by the learner for questions in the current subset.

At 920B, in response to determining that one or more concepts are not represented in the current subset, the processing agent may select a next question for adding to the current subset based on a maximization of a first objective function over a question space equal to questions that map to the one or more concepts (as indicated by the matrix W) minus questions of the current subset. For each question, the first objective function is based on selected portions of the question-concept matrix W and a grade variance estimate corresponding to the question.

In some embodiments, a question i is said to map (be related) to a concept j if the element wᵢⱼ of the matrix W is greater than zero. In alternative embodiments, the “greater than zero” condition may be replaced with a “greater than ε” condition, where c is a small positive number.

At 920C, the processing agent may add the selected next question to the current subset of questions.

At 920D, the processing agent may receive a next grade corresponding to an answer provided by the learner in response to the selected next question.

In some embodiments, for each question, the selected portions of the question-concept matrix W include: a restriction of the question-concept matrix W corresponding to questions of the current subset; and a row of the question-concept matrix W corresponding to the question.

In some embodiments, the question selection process also includes, in response to determining that all the concepts of the set of concepts are represented in the current subset, performing operations including the following operations. First, the processing agent computes a maximum likelihood estimate (MLE) for a concept understanding vector and an ability parameter of the learner based on grades corresponding to the current subset of questions, e.g., as variously described above. Second, in response to said MLE computation determining that the concept understanding vector and the ability parameter both exist, selecting the next question for adding to the current subset based on a maximization of a second objective function over the set of questions minus the current subset of questions. For each question, the second objective function is based on: a restriction of the question-concept matrix W corresponding to the current subset of questions; a row of the of the question-concept matrix W corresponding to the question; and an evaluation of a grade variance expression for the question using the concept understanding vector and the ability parameter.

In some embodiments, the question selection process may also include: administering the selected next question to the learner via a computer network; and receiving an answer submitted by the learner in response to the selected next question via the network. Furthermore, the question selection process may also include automatically grading the answer submitted by the learner based on a stored correct answer in order to obtain said next grade.

In some embodiments, the above-described initial subset of questions includes at least K+1 questions, where K is the number of concepts in the set of concepts.

Additional embodiments are disclosed in the following numbered paragraphs. These embodiments may be employed, e.g., in cases where the learner ability parameter is not being used. Any of these additional embodiments may be combined with any subset of the features, elements and embodiments described above.

1. A method comprising:

receiving a matrix W representing strengths of association between questions in a set of questions and concepts in a set of concepts; and

receiving a graded answer matrix representing grades for answers submitted by learners in response to the set of questions;

selecting a subset of the questions, where said selecting is performed by a computer system, where the number of questions in the subset is less than or equal to the number of questions in the set of questions but greater than or equal to the number of concepts in the set of concepts, where said selecting includes:

(a) for each of the concepts, selecting a corresponding question from the set of questions based on maximization of a variance-association product over the set of questions, where the variance-association product for each question is a product of a grade variance estimate for the question and a function of an element of the matrix W corresponding to the question and the concept, where the grade variance estimate for each question is determined using a corresponding portion of the graded answer matrix; and

storing information identifying the selected subset of questions in a memory, where the selected subset of questions is configured to be administered to a new set of learners for testing knowledge of the new set of learners on the set of concepts.

2. The method of paragraph 1, further comprising:

displaying a visual representation of the selected subset of questions using a display device; and/or

administering the selected subset of questions to the new set of learners, where said administering is performed by the computer system or by one or more other computer systems.

3. The method of paragraph 1, where, for each question, the first objective function is computed based on: a restriction of the matrix W corresponding to the question plus questions selected in (a), and, the grade variance estimates for the question and the questions selected in (a).

4. The method of paragraph 1, further comprising: executing a sparse factor analysis algorithm to estimate an extent of concept understanding for each of the concepts based on grades for answers provided by the new set of learners in response to being administered the selected subset of questions.

5. The method of paragraph 1, where the number q of questions in the subset is greater than the number of concepts in the set of concepts, where said selecting includes: (b) one or more iterations of an induction operation, where the induction operation includes selecting an (l+1)^{th} question for the subset based on a maximization of a second objective function over the set of questions minus the l questions already determined for the subset, where, for each question, the second objective function is based on:

a restriction of the matrix W corresponding to the l already determined questions;

a row of the matrix W corresponding to the question; and

the grade variance estimate corresponding to the question.

6. The method of paragraph 5, where the number q is equal to the number of questions in said set of questions, where (a) and (b) define a ranking of the questions of the set of questions according to relevance for testing the set of concepts.

7. The method of paragraph 1, where rows of the graded answer matrix correspond respectively to the questions in the set of questions, where columns of the graded answer matrix correspond respectively to the learners.

8. The method of paragraph 1, where the computer system is operated by an Internet-based educational service provider.

Computer System

FIG. 10 illustrates one embodiment of a computer system 1000 that may be used to perform any of the method embodiments described herein, or, any combination of the method embodiments described herein, or any subset of any of the method embodiments described herein, or, any combination of such subsets.

Computer system 1000 may include a processing unit 1010, a system memory 1012, a set 1015 of one or more storage devices, a communication bus 1020, a set 1025 of input devices, and a display system 1030.

System memory 1012 may include a set of semiconductor devices such as RAM devices (and perhaps also a set of ROM devices).

Storage devices 1015 may include any of various storage devices such as one or more memory media and/or memory access devices. For example, storage devices 1015 may include devices such as a CD/DVD-ROM drive, a hard disk, a magnetic disk drive, magnetic tape drives, etc.

Processing unit 1010 is configured to read and execute program instructions, e.g., program instructions stored in system memory 1012 and/or on one or more of the storage devices 1015. Processing unit 1010 may couple to system memory 1012 through communication bus 1020 (or through a system of interconnected busses, or through a network). The program instructions configure the computer system 100 to implement a method, e.g., any of the method embodiments described herein, or, any combination of the method embodiments described herein, or, any subset of any of the method embodiments described herein, or any combination of such subsets.

Processing unit 1010 may include one or more processors (e.g., microprocessors).

One or more users may supply input to the computer system 100 through the input devices 1025. Input devices 1025 may include devices such as a keyboard, a mouse, a touch-sensitive pad, a touch-sensitive screen, a drawing pad, a track ball, a light pen, a data glove, eye orientation and/or head orientation sensors, a microphone (or set of microphones), or any combination thereof.

The display system 1030 may include any of a wide variety of display devices representing any of a wide variety of display technologies. For example, the display system may be a computer monitor, a head-mounted display, a projector system, a volumetric display, or a combination thereof. In some embodiments, the display system may include a plurality of display devices. In one embodiment, the display system may include a printer and/or a plotter.

In some embodiments, the computer system 1000 may include other devices, e.g., devices such as one or more graphics accelerators, one or more speakers, a sound card, a video camera and a video card, a data acquisition system.

In some embodiments, computer system 1000 may include one or more communication devices 1035, e.g., a network interface card for interfacing with a computer network (e.g., the Internet). As another example, the communication device 1035 may include one or more specialized interfaces for communication via any of a variety of established communication standards or protocols.

The computer system may be configured with a software infrastructure including an operating system, and perhaps also, one or more graphics APIs (such as OpenGL®, Direct3D, Java 3D™).

Any of the various embodiments described herein may be realized in any of various forms, e.g., as a computer-implemented method, as a computer-readable memory medium, as a computer system, etc. A system may be realized by one or more custom-designed hardware devices such as ASICs, by one or more programmable hardware elements such as FPGAs, by one or more processors executing stored program instructions, or by any combination of the foregoing.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a mobile device, a wearable computer, a computer embedded in a living organism, etc.

Any of the various embodiments described herein may be combined to form composite embodiments. Furthermore, any of the various features, embodiments and elements described in U.S. Provisional Application No. 61/840,853 (filed Jun. 28, 2013) may be combined with any of the various embodiments described herein.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving a matrix W representing strengths of association between questions in a set of questions and concepts in a set of concepts; and
receiving a graded answer matrix representing grades for answers submitted by learners in response to the set of questions;
selecting a subset of the questions, wherein said selecting is performed by a computer system, wherein the number of questions in the subset is less than or equal to the number of questions in the set of questions but greater than or equal to one plus the number of concepts in the set of concepts, wherein said selecting includes:
(a) for each of the concepts, selecting a corresponding question from the set of questions based on maximization of a variance-association product over the set of questions, wherein the variance-association product for each question is a product of a grade variance estimate for the question and a function of an element of the matrix W corresponding to the question and the concept, wherein the grade variance estimate for each question is determined using a corresponding portion of the graded answer matrix; and
(b) selecting an additional question from the set of the questions based on a maximization of a first objective function over the set of questions minus the questions selected in (a);
storing information identifying the selected subset of questions in a memory, wherein the selected subset of questions is configured to be administered to a new set of learners for testing knowledge of the new set of learners on the set of concepts.

2. The method of claim 1, further comprising:
displaying a visual representation of the selected subset of questions using a display device; and/or
administering the selected subset of questions to the new set of learners, wherein said administering is performed by the computer system or by one or more other computer systems.

3. The method of claim 1, wherein, for each question, the first objective function is computed based on: a restriction of the matrix W corresponding to the question plus questions selected in (a), and, the grade variance estimates for the question and the questions selected in (a).

4. The method of claim 1, further comprising:
executing a sparse factor analysis algorithm to estimate an extent of concept understanding for each of the concepts based on grades for answers provided by the new set of learners in response to being administered the selected subset of questions.

5. The method of claim 1, wherein the number q of questions in the subset is greater than one plus the number of concepts in the set of concepts, wherein said selecting includes (c) one or more iterations of an induction operation, wherein the induction operation includes selecting an (l+1)^{th} question for the subset based on a maximization of a second objective function over the set of questions minus the l questions already determined for the subset, wherein, for each question, the second objective function is based on:
a restriction of the matrix W corresponding to the l already determined questions;
a row of the matrix W corresponding to the question; and
the grade variance estimate corresponding to the question.

6. The method of claim 5, wherein the number q is equal to the number of questions in said set of questions, wherein (a), (b) and (c) define a ranking of the questions of the set of questions according to relevance for testing the set of concepts.

7. The method of claim 1, wherein rows of the graded answer matrix correspond respectively to the questions in the set of questions, wherein columns of the graded answer matrix correspond respectively to the learners.

8. The method of claim 1, wherein the computer system is operated by an Internet-based educational service provider.

9. A non-transitory memory medium storing program instructions, wherein the program instructions, when executed by a computer system, cause the computer system to implement:
receiving a matrix W representing strengths of association between questions in a set of questions and concepts in a set of concepts;
receiving a graded answer matrix representing grades for answers submitted by learners in response to the set of questions;
selecting a subset of the questions, wherein said selecting is performed by a computer system, wherein the number of questions in the subset is less than or equal to the number of questions in the set of questions but greater than or equal to one plus the number of concepts in the set of concepts, wherein said selecting includes:
(a) for each of the concepts, selecting a corresponding question from the set of questions based on maximization of a variance-association product over the set of questions, wherein the variance-association product for each question is a product of a grade variance estimate for the question and a function of an element of the matrix W corresponding to the question and the concept, wherein the grade variance estimate for each question is determined using a corresponding portion of the graded answer matrix; and
(b) selecting an additional question from the set of the questions based on a maximization of a first objective function over the set of questions minus the questions selected in (a);
storing information identifying the selected subset of questions in memory, wherein the selected subset of questions is configured to be administered to a new set of learners for testing knowledge of the new set of learners on the set of concepts.

10. The non-transitory memory medium of claim 9, further comprising:
displaying a visual representation of the selected subset of questions using a display device; and/or
administering the selected subset of questions to the new set of learners, wherein said administering is performed by the computer system or by one or more other computer systems.

11. The non-transitory memory medium of claim 9, wherein, for each question, the first objective function is computed based on: a restriction of the matrix W corresponding to the question plus questions selected in (a), and, the grade variance estimates for the question and the questions selected in (a).

12. The non-transitory memory medium of claim 9, further comprising:
executing a sparse factor analysis algorithm to estimate an extent of concept understanding for each of the concepts based on grades for answers provided by the new set of learners in response to being administered the selected subset of questions.

13. The non-transitory memory medium of claim 9, wherein the number q of questions in the subset is greater than one plus the number of concepts in the set of concepts, wherein said selecting includes (c) one or more iterations of an induction operation, wherein the induction operation includes selecting an (l+1)^{th} question for the subset based on a maximization of a second objective function over the set of questions minus the l questions already determined for the subset, wherein, for each question, the second objective function is based on:
a restriction of the matrix W corresponding to the l already determined questions;
a row of the matrix W corresponding to the question; and
the grade variance estimate corresponding to the question.

14. The non-transitory memory medium of claim 13, wherein the number q is equal to the number of questions in said set of questions, wherein (a), (b) and (c) define a ranking of the questions of the set of questions according to relevance for testing the set of concepts.

15. The non-transitory memory medium of claim 9, wherein rows of the graded answer matrix correspond respectively to the questions in the set of questions, wherein columns of the graded answer matrix correspond respectively to the learners.

16. A method for testing concept knowledge of a learner, the method comprising:
receiving initial grades for answers supplied by a learner in response to an initial subset of questions selected from a set of questions, wherein the set of questions are related to a set of concepts, wherein the number of questions in the initial subset is equal to at least one plus the number of concepts in the set of concepts, wherein strengths of association between questions in the set of questions and concepts in the set of concepts are represented by a matrix W;
performing one or more iterations of a question selection process to successively add one or more questions to a current subset, wherein, prior to a first of the one or more iterations, the current subset is set equal to the initial subset, wherein said receiving and said performing are implemented by a set of one or more computer systems, wherein the question selection process includes:
determining if there are any concepts of the set of concepts that are not represented in the current subset of questions based on the matrix W and grades for answers provided by the learner for questions in the current subset;
in response to determining that one or more concepts are not represented in the current subset, selecting a next question for adding to the current subset based on a maximization of a first objective function over a question space equal to questions that map to the one or more concepts, as indicated by the matrix W, minus questions of the current subset, wherein, for each question, the first objective function is based on selected portions of the matrix W and a grade variance estimate corresponding to the question;
adding the selected next question to the current subset of questions; and
receiving a next grade corresponding to an answer provided by the learner in response to the selected next question.

17. The method of claim 16, wherein, for each question, the selected portions of the matrix W include:
a restriction of the matrix W corresponding to questions of the current subset;
a row of the matrix W corresponding to the question.

18. The method of claim 16, wherein the question selection process also includes, in response to determining that all the concepts of the set of concepts are represented in the current subset, performing operations including:
computing a maximum likelihood estimate for a concept understanding vector and an ability parameter of the learner based on grades corresponding to the current subset of questions;
in response to said computing determining that the concept understanding vector and the ability parameter both exist, selecting the next question for adding to the current subset based on a maximization of a second objective function over the set of questions minus the current subset of questions, wherein, for each question, the second objective function is based on: a restriction of the matrix W corresponding to the current subset of questions; a row of the of the matrix W corresponding to the question; and an evaluation of a grade variance expression for the question using the concept understanding vector and the ability parameter.

19. The method of claim 16, wherein the question selection process also includes:
administering the selected next question to the learner via a computer network; and
receiving an answer submitted by the learner in response to the selected next question via the network.

20. The method of claim 16, wherein the question selection process also includes:
automatically grading the answer submitted by the learner based on a stored correct answer in order to obtain said next grade.
